(19) United States
(12) Patent Application Publication
(10) Pub. No.: US 2026/0164496 A1
(43) Pub. Date: Jun. 11, 2026

(54) COMMUNICATION METHODS AND APPARATUSES, DEVICE AND STORAGE MEDIUM

(71) Applicant: Beijing Xiaomi Mobile Software Co., Ltd., Beijing (CN)

(72) Inventor: Mingju LI, Beijing (CN)

(21) Appl. No.: 19/125,629

(22) PCT Filed: Nov. 2, 2022
(86) PCT No.: PCT/CN2022/129372

§ 371 Date: Apr. 29, 2025

(51) Int. Cl. H04W 76/27; H04L 5/00; H04W 72/566

(52) U.S. Cl. CPC H04W 76/27; H04L 5/0094; H04W 72/566

(57) ABSTRACT

A communication, method, performed by a terminal, the communication method including: determining, in a case where the terminal is in a non-connected state, a first configuration parameter; determining a reference signal processing window, based on the first configuration parameter; and processing a reference signal based on the reference signal processing window.

### CROSS-REFERENCE TO RELATED APPLICATION

The present application is a U.S. National Stage of International Application No. PCT/CN 2022/129372, filed on Nov. 2, 2022, the contents of all of which are incorporated herein by reference in their entirety for all purposes.

### BACKGROUND OF THE INVENTION

In related art, positioning methods on how to position with low power consumption and high accuracy have been discussed in some existing solutions. These existing solutions focus on how to position a terminal. The terminal needs to transmit a reference signal and some other information. The some other information may be channels or signals except the reference signal.

### SUMMARY OF THE INVENTION

The present disclosure relates to the field of communication technology, and particularly relates to a communication method, a communication apparatus, a communication device, and a storage medium.

A first aspect of embodiments of the present disclosure provides a communication method. The method is performed by a terminal. The method includes: determining, in a case where the terminal is in a non-connected state, a first configuration parameter configured to configure a reference signal processing window; determining the reference signal processing window based on the first configuration parameter; and processing a reference signal based on the reference signal processing window.

A second aspect of the embodiments of the present disclosure provides a communication method. The method is performed by a network device. The method includes: determining, in a case where a terminal is in a non-connected state, a first configuration parameter configured to configure a reference signal processing window, where the first configuration parameter is configured to instruct the terminal to determine the reference signal processing window and to process a reference signal based on the reference signal processing window.

A third aspect of the embodiments of the present disclosure provides a communication apparatus. The apparatus is configured in a terminal. The apparatus includes: a determination module configured to determine, in a case where the terminal is in a non-connected state, a first configuration parameter configured to configure a reference signal processing window, where the determination module is further configured to determine the reference signal processing window based on the first configuration parameter; and a processing module configured to process a reference signal based on the reference signal processing window.

A fourth aspect of the embodiments of the present disclosure provides a communication apparatus. The apparatus is configured in a network device. The apparatus includes: a determination module configured to determine, in a case where a terminal is in a non-connected state, a first configuration parameter configured to configure a reference signal processing window, where the first configuration parameter is configured to instruct the terminal to determine the reference signal processing window and to process a reference signal based on the reference signal processing window.

A fifth aspect of the embodiments of the present disclosure provides a communication device. The device includes: a processor; and a memory configured to store processor-executable instructions. The processor is configured to perform any method according to the first aspect.

A sixth aspect of the embodiments of the present disclosure provides a communication device. The device includes: a processor; and a memory configured to store processor-executable instructions. The processor is configured to perform any method according to the second aspect.

A seventh aspect of the embodiments of the present disclosure provides a non-transitory computer-readable storage medium. Instructions in the non-transitory computer-readable storage medium, when executed by a processor of a terminal, cause the terminal to perform any method according to the first aspect.

An eighth aspect of the embodiments of the present disclosure provides a non-transitory computer-readable storage medium. Instructions in the non-transitory computer-readable storage medium, when executed by a processor of a network device, cause the network device to perform any method according to the second aspect.

### BRIEF DESCRIPTION OF DRAWINGS

Accompanying drawings, incorporated in the description as a constituent part of the description, illustrate embodiments conforming to the present disclosure, and serve to describe principles of the present disclosure together with the description.

FIG. 1 is a schematic diagram of a wireless communication system according to an example.

FIG. 2 is a flowchart of a communication method according to an example.

FIG. 3 is a flowchart of another communication method according to an example.

FIG. 4 is a flowchart of yet another communication method according to an example.

FIG. 5 is a flowchart of yet another communication method according to an example.

FIG. 6 is a flowchart of yet another communication method according to an example.

FIG. 7 is a flowchart of yet another communication method according to an example.

FIG. 8 is a flowchart of yet another communication method according to an example.

FIG. 9 is a flowchart of yet another communication method according to an example.

FIG. 10 is a flowchart of still another communication method according to an example.

FIG. 11 is a schematic diagram of a communication apparatus according to an example.

FIG. 12 is a schematic diagram of another communication apparatus according to an example.

FIG. 13 is a schematic diagram of a communication device according to an example.

FIG. 14 is a schematic diagram of another communication device according to an example.

### DETAILED DESCRIPTION OF THE INVENTION

Examples will be described in detail and their instances are shown in the accompanying drawings. When the following description involves the accompanying drawings, unless otherwise specified, an identical number in different accompanying drawings denotes identical or similar elements. Implementations described in the following examples do not denote all implementations consistent with the present disclosure.

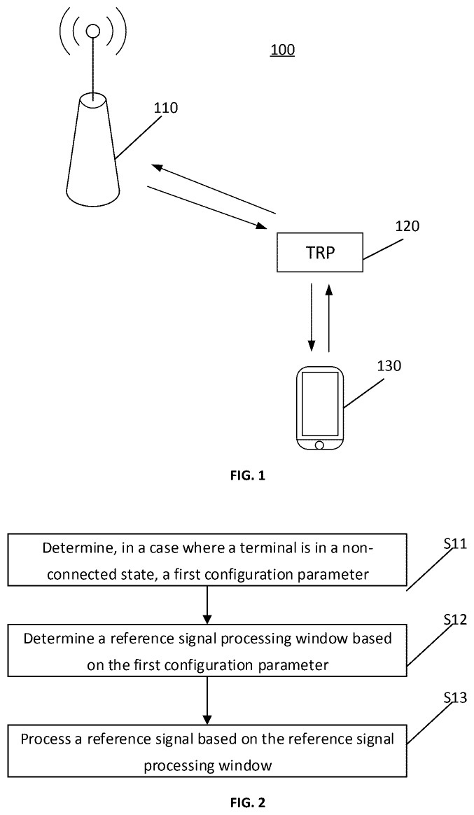

A communication method according to the present disclosure may be performed by a wireless communication system as shown in FIG. 1. As may be seen from FIG. 1, the wireless communication system 100 may include a network device 110, a transmission reception point (TRP) 120, and a terminal 130. The network device 110, the TRP 120 and the terminal 130 may be in communication with each other through radio resources, for instance, transmit and receive corresponding information.

It may be understood that the wireless communication system 100 shown in FIG. 1 is merely illustrative, and the wireless communication system 100 may further include other network devices, such as a core network device, a radio relay device, and a radio backhaul device, which are not shown in FIG. 1. An embodiment of the present disclosure does not limit a number of network devices and a number of terminals included in the wireless communication system 100.

It may be further understood that the wireless communication system 100 of the embodiment of the present disclosure is a network providing a wireless communication function. The wireless communication system 100 may use different communication technologies, such as code division multiple access (CDMA), wideband code division multiple access (WCDMA), time division multiple access (TDMA), frequency division multiple access (FDMA), orthogonal frequency-division multiple access (OFDMA), single carrier FDMA (SC-FDMA), and carrier sense multiple access with collision avoidance. According to capacity, speeds, delays and other factors of different networks, the networks may be divided into a 2 generation (2G) network, a 3G network, a 4G network, or a future evolution network, and for instance, a 5G network. The 5G network may also be referred to as new radio (NR). For convenience of description, the wireless communication network may be called a network for short in some cases in the present disclosure.

Further, the network device 110 involved in the present disclosure may also be referred to as a radio access network device or a core network device. The radio access network device may be a base station, an evolved node B, a home base station, an access point (AP) in a wireless fidelity (WIFI) system, a radio relay node, a radio backhaul node, a transmission point (TP), a transmission and reception point (TRP), etc., or may be the next generation node B (gNB) in an NR system, or may be a component or part of a device that constitutes a base station. In a case where the wireless communication system 100 is a vehicle-to-everything (V2X) communication system, the network device 110 may be a vehicular device. It is to be understood that the embodiment of the present disclosure does not limit technologies and device forms used by the network device 110.

In some embodiments, the core network device may include a location management function network element. In an example, the location management function network element includes a location server. The location server may be implemented as any one of: a location management function (LMF)-enhanced serving mobile location center (E-SMLC), a secure user plane location (SUPL), or a SUPL location platform (SUPL LP).

Further, the TRP 120 involved in the present disclosure may transmit beams in different directions to the terminal 130 for wireless communication.

Further, the terminal 130 involved in the present disclosure may also be referred to as a terminal device, user equipment (UE), a mobile station (MS), a mobile terminal (MT), etc. The terminal 130 may be a device that provides at least one of voice or data connectivity to a user. For instance, the terminal 130 may be a handheld device having a radio connection function, a vehicular device, etc. At present, some instances of the terminal 130 include, for instance, a mobile phone, a pocket personal computer (PPC), a handheld computer, a personal digital assistant (PDA), a notebook computer, a tablet computer, a wearable device, or a vehicular device. In addition, in a case where the wireless communication system 100 is a V2X communication system, the terminal 130 may also be a vehicular device. It is to be understood that the embodiment of the present disclosure does not limit technologies and device forms used by the terminal 130.

In the embodiment of the present disclosure, the network device 110 and the terminal 130 may use any feasible wireless communication technology to implement mutual data transmission. A transmission channel corresponding to data transmitted by the network device 110 to the terminal 130 is referred to as a downlink (DL) channel. A transmission channel corresponding to data transmitted by the terminal 130 to the network device 110 is referred to as an uplink (UL) channel. It may be understood that the network device 110 involved in the embodiment of the present disclosure may be a base station. The network device 110 may be any other possible network device, and the terminal 130 may be any possible terminal, which are not limited by the present disclosure.

In related art, positioning methods on how to position with low power consumption and high accuracy have been discussed in a release (Rel) 18, which focus on how to position a terminal. The terminal needs to transmit a reference signal and some other information. The some other information may be channels or signals except the reference signal. However, due to an interval currently set between the reference signal and the some other information, the terminal fails to enter a state of low power consumption. In this case, the terminal fails to demonstrate the advantage of low power consumption in an inactive state (RRC_INACTIVE) or an idle state (RRC_IDLE). Thus, the terminal may generate high power consumption during positioning at present.

However, in order to adapt to a low-power-communication scenario, excessive power consumption of the terminal in the inactive state or the idle state has to be avoided. Thus, it is a pressing issue to reduce power consumption caused by transmission of the reference signal and the some other channels or signal resources in a case where the terminal is in the inactive state or the idle state.

Thus, in the present disclosure, a first configuration parameter configured to configure a reference signal processing window is determined, such that a reference signal is processed within the corresponding reference signal processing window, and further power consumption caused by terminal positioning is reduced.

FIG. 2 is a flowchart of a communication method according to an example. As shown in FIG. 2, the method is performed by a terminal. The method may include the following steps S11, S12, and S13.

In step S11, in a case where the terminal is in a non-connected state, a first configuration parameter is determined.

In some embodiments, in a case where the terminal is in the non-connected state, the terminal may determine the first configuration parameter configured to configure a reference signal processing window.

For instance, the terminal being in the non-connected state may include that the terminal is in an RRC_INACTIVE state or an RRC_IDLE state.

In some embodiments, a resource corresponding to the reference signal processing window may be used by the terminal to process a reference signal.

In some embodiments, the reference signal may include at least one of a positioning reference signal (PRS) or a sounding reference signal (SRS).

In step S12, the reference signal processing window is determined based on the first configuration parameter.

In some embodiments, the terminal may determine the reference signal processing window based on the first configuration parameter determined in step S11.

In step S13, a reference signal is processed based on the reference signal processing window.

In some embodiments, the terminal may process, based on the reference signal processing window determined in step S12, the reference signal within the reference signal processing window, for instance, transmit and/or receive the reference signal, or transmit and/or receive other information. It may be understood that the other information may be any channel except a channel transmitting the reference signal, or may be any signal except the reference signal.

In the present disclosure, the first configuration parameter configured to configure the reference signal processing window is determined, such that the reference signal is processed within the corresponding reference signal processing window, and further power consumption caused by terminal positioning is reduced.

In the communication method according to the embodiment of the present disclosure, in a case where the non-connected state is an inactive state, the first configuration parameter is determined in any one of the following ways: receiving a radio resource control (RRC) release message transmitted by a network device, where the RRC release message includes the first configuration parameter; or determining, based on a second configuration parameter while the terminal is in a connected state, the first configuration parameter, where the second configuration parameter is a configuration parameter configured to configure the reference signal processing window while the terminal is in the connected state.

In some embodiments, in a case where the terminal is in the RRC_INACTIVE state, the terminal may receive a first RRC release message transmitted by the network device. The first RRC release message includes the first configuration parameter. The terminal may determine the first configuration parameter based on the first RRC release message.

For instance, in a case where the network device configures the first RRC release message for the terminal, the first configuration parameter may be carried in the first RRC release message. The terminal may determine the first configuration parameter based on the first RRC release message configured. For instance, the terminal may determine the first configuration parameter based on the first configuration parameter carried in the first RRC release message.

In some embodiments, in a case where the terminal is in the RRC_INACTIVE state, the terminal may determine, based on the second configuration parameter while the terminal is in the connected state (RRC_CONNECTED), the first configuration parameter. The second configuration parameter is the configuration parameter configured to configure the reference signal processing window while the terminal is in the RRC_CONNECTED state.

For instance, in a case where the terminal is in the RRC_CONNECTED state, the terminal may be configured with the second configuration parameter. The second configuration parameter is configured to indicate the reference signal processing window in which the terminal processes the reference signal while in the RRC_CONNECTED state. The reference signal processing window in which the terminal processes the reference signal while in the RRC_CONNECTED state may also be used as a reference signal processing window in which the terminal processes the reference signal while in the RRC_IDLE state. That is, the terminal may use the second configuration parameter as the first configuration parameter. Accordingly, based on the second configuration parameter, the terminal may continue to use the reference signal processing window in which the terminal processes the reference signal while in the RRC_CONNECTED state.

The present disclosure provides a way for the terminal in the inactive state to determine the reference signal processing window, such that the terminal may process the reference signal within the corresponding reference signal processing window, and further power consumption caused by terminal positioning is reduced.

In the communication method according to the embodiment of the present disclosure, in a case where the non-connected state is an idle state, the first configuration parameter is determined in any one of the following ways: receiving, in a case where the network device is a core network device, a configuration parameter configured to indicate the first configuration parameter and transmitted by the core network device; receiving a configuration parameter configured to indicate the first configuration parameter and carried in broadcast information transmitted by the network device; receiving the first configuration parameter in a second RRC release message transmitted by the network device; or receiving, during a random access (RA) procedure, a configuration parameter configured to indicate the first configuration parameter and transmitted by the network device.

In some embodiments, in a case where the terminal is in the RRC_IDLE state and the network device is the core network device, the terminal may receive a configuration parameter transmitted by the core network device and determine the first configuration parameter based on the configuration parameter transmitted by the core network device.

For instance, the core network device may be an LMF network element. That is, the terminal in the RRC_IDLE state may determine the first configuration parameter based on an LMF configuration.

In some embodiments, in a case where the terminal is in the RRC_IDLE state, the terminal may receive broadcast information transmitted by the network device. The broadcast information carries a configuration parameter. The terminal may determine the first configuration parameter based on the configuration parameter carried in the broadcast information. That is, the terminal in the RRC_IDLE state may determine the first configuration parameter based on the broadcast information.

In some embodiments, in a case where the terminal is in the RRC_IDLE state, the terminal may receive a configuration parameter in the second RRC release message transmitted by the network device. The terminal may determine the first configuration parameter based on the configuration parameter in the second RRC release message. That is, the terminal in the RRC_IDLE state may determine the first configuration parameter based on the second RRC release message.

In some embodiments, in a case where the terminal is in the RRC_IDLE state, the terminal may receive a configuration parameter transmitted by the network device in the RA procedure, and determine the first configuration parameter based on the configuration parameter transmitted by the network device in the RA procedure. That is, the terminal in the RRC_IDLE state may obtain the first configuration parameter through RA.

For instance, the first configuration parameter may be determined based on a message (MSG) 2 (that is, a random access response (RAR)), an MSG 4, or an MSG B in the RA procedure. The MSG 2 and the MSG 4 are feedbacks transmitted by an access network device to the terminal in step two and step four respectively in four-step random access procedure. The MSG B is feedback transmitted by the access network device to the terminal in two-step random access procedure.

The present disclosure provides a way for the terminal in the idle state to determine the reference signal processing window, such that the terminal may process the reference signal within the corresponding reference signal processing window, and further power consumption caused by terminal positioning is reduced.

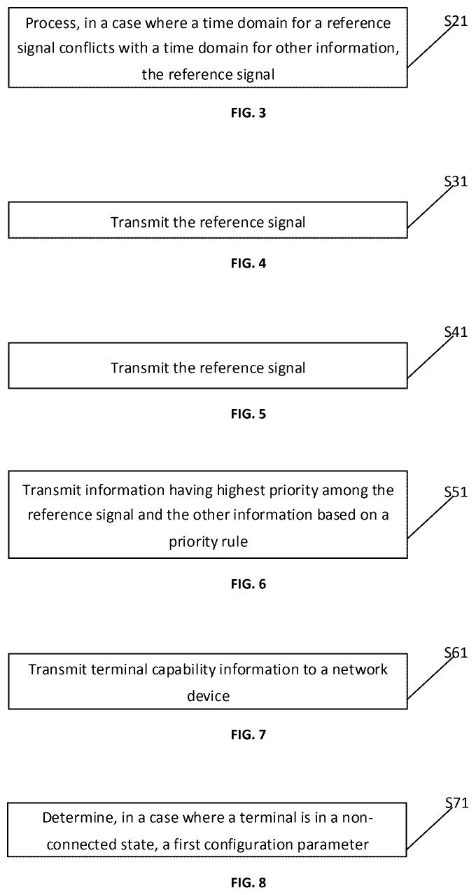

In the communication method according to the embodiment of the present disclosure, FIG. 3 is a flowchart of another communication method according to an example. As shown in FIG. 3, the step that the reference signal is processed in step S13 may include the following step S21.

In step S21, in a case where a time domain for the reference signal conflicts with a time domain for other information, the reference signal is processed.

In some embodiments, in a case where the time domain for the reference signal conflicts with the time domain for the other information, the terminal may process the reference signal. The other information may include at least one of any channel or any signal except the reference signal.

For instance, the terminal may process the reference signal within the reference signal processing window according to locations of the time domain for the reference signal and the time domain for the other information, for example, process the reference signal in a case where the time domain for the reference signal conflicts with the time domain for the other information. For instance, the terminal may receive a PRS, not receive a PRS, transmit an SRS, not transmit an SRS, transmit other information, and/or not transmit other information.

In some embodiments, whether the time domain for the reference signal conflicts with the time domain for the other information may be determined according to a conflict criterion preset or specified in a protocol.

In the present disclosure, the reference signal is processed within the reference signal processing window based on a conflict between the time domain for the reference signal and the time domain for the other information. In this way, power consumption caused by terminal positioning is reduced.

In the communication method according to the embodiment of the present disclosure, the other information includes at least one of: at least one of a channel or a signal of a serving cell; or at least one of a channel or a signal of a neighboring cell.

In some embodiments, the other information may include at least one of the channel or the signal of the serving cell.

In some embodiments, the other information may include at least one of the channel or the signal of the neighboring cell.

The present disclosure may be applied to a scenario where a time domain for at least one of the channel or the signal of the serving cell conflicts with the time domain for the reference signal, and may further be applied to a scenario where a time domain for at least one of the channel or the signal of the neighboring cell conflicts with the time domain for the reference signal. Thus, in different scenarios, the terminal may process the reference signal within the corresponding reference signal processing window, and further power consumption caused by terminal positioning is reduced.

In the communication method according to the embodiment of the present disclosure, at least one of the channel or the signal of the serving cell may include at least one of: a synchronization signal block (SSB) of the serving cell; a system information block (SIB) 1 of the serving cell; a control resource set (CORESET) 0 of the serving cell; an MSG 2 or an MSG B of the serving cell; a paging message of the serving cell; or uplink or downlink small data transmission (SDT) of the serving cell.

In some embodiments, at least one of the channel or the signal of the serving cell may include the SSB of the serving cell.

In some embodiments, at least one of the channel or the signal of the serving cell may include the SIB 1 of the serving cell.

In some embodiments, at least one of the channel or the signal of the serving cell may include the CORESET 0 of the serving cell.

The CORESET 0 may be considered as a special CORESET. The CORESET 0 indicates a corresponding resource block obtained by the terminal from a physical downlink control channel (PDCCH)-config SIB 1 in a cell search procedure, and a number of symbols corresponding to a type 0-PDCCH common search space (CSS) set associated with the resource block.

In some embodiments, at least one of the channel or the signal of the serving cell may include the MSG 2 or the MSG B of the serving cell.

In some embodiments, at least one of the channel or the signal of the serving cell may include the paging message of the serving cell.

In some embodiments, at least one of the channel or the signal of the serving cell may include the uplink or downlink SDT of the serving cell.

The present disclosure provides various different channels and/or signals of the serving cells, such that in a scenario where the time domain for at least one of the channel or the signal of the serving cell conflicts with the time domain for the reference signal, the terminal may process the reference signal within the corresponding reference signal processing window, and further power consumption caused by terminal positioning is reduced.

In the communication method according to the embodiment of the present disclosure, at least one of the channel or the signal of the neighboring cell may include at least one of: an SSB of the neighboring cell; an SIB 1 of the neighboring cell; a channel state information reference signal (CSI-RS) of the neighboring cell; or a CORESET 0 of the neighboring cell.

In some embodiments, at least one of the channel or the signal of the neighboring cell may include the SSB of the neighboring cell.

In some embodiments, at least one of the channel or the signal of the neighboring cell may include the SIB 1 of the neighboring cell.

In some embodiments, at least one of the channel or the signal of the neighboring cell may include the CSI-RS of the neighboring cell.

In some embodiments, at least one of the channel or the signal of the neighboring cell may include the CORESET 0 of the neighboring cell.

The present disclosure provides various different channels and/or signals of the neighboring cells, such that in a scenario where the time domain for at least one of the channel or the signal of the neighboring cell conflicts with the time domain for the reference signal, the terminal may process the reference signal within the corresponding reference signal processing window, and further power consumption caused by terminal positioning is reduced.

In the communication method according to the embodiment of the present disclosure, in a case where the terminal transmits the reference signal within an initial bandwidth part (BWP), it is determined that the time domain for the reference signal conflicts with the time domain for the other information in at least one of the following ways: determining that the time domain for the reference signal conflicts with the time domain for the other information, in a case where the reference signal overlaps with the other information in at least one symbol; determining that the time domain for the reference signal conflicts with a time domain for second other information, in a case where first other information is at N symbols before a starting location of the reference signal processing window and the second other information is within the reference signal processing window, where N is less than a first threshold, the other information includes the first other information and the second other information, and the first other information is configured to indicate a location of the time domain for the second other information; determining that the time domain for the reference signal conflicts with the time domain for the other information, in a case where the reference signal overlaps with a first time window in at least one symbol, where a starting location of the first time window is at X1 symbols or slots before the other information, and an ending location of the first time window is at Y1 symbols or slots after the other information; or determining that the time domain for the reference signal conflicts with the time domain for the other information, in a case where a second time window overlaps with the other information in at least one symbol, where a starting location of the second time window is at X2 symbols or slots before the reference signal, an ending location of the second time window is at Y2 symbols or slots after the reference signal, X1 and X2 may be identical or not, Y1 and Y2 may be identical or not, and the reference signal processing window includes at least one symbol of at least one of the first time window or the second time window.

In one embodiment, the initial BWP may include at least one of an initial DL BWP and an initial UL BWP. It may be understood that the terminal may receive or not receive a PRS on the initial DL BWP, and the terminal may transmit or not transmit an SRS on the initial UL BWP.

In one embodiment, the terminal may determine, in a case where the reference signal overlaps with the other information in at least one symbol, that the time domain for the reference signal conflicts with the time domain for the other information.

For instance, the terminal may determine, in a case where at least one of the PRS or the SRS overlaps with the other information in at least one symbol, that the time domain for the reference signal conflicts with the time domain for the other information. This way for conflict determination may be referred to as a conflict criterion 1.

In one embodiment, the terminal may determine, in a case where the first other information is at the N symbols before the starting location of the reference signal processing window and the second other information is within the reference signal processing window, that the time domain for the reference signal conflicts with the time domain for the second other information. N is less than the first threshold. The other information includes the first other information and the second other information. The first other information is configured to indicate the location of the time domain for the second other information.

For instance, the terminal receives the first other information at the N symbols before the starting location of the reference signal processing window. The first other information is configured to indicate the location of the time domain for the second other information, and the second other information is within the reference signal processing window. The terminal may determine that the time domain for the reference signal conflicts with the time domain for the second other information. This conflict determination mode may be referred to as a conflict criterion 2.

It may be understood that the first threshold may be preset. In this case, after the terminal receives the first other information at the N symbols before the starting location of the reference signal processing window, the terminal does not have enough time to analyze the first other information, such that the terminal cannot obtain a location of the second other information. Thus, the terminal determines that the time domain for the reference signal conflicts with the time domain for the second other information.

In one embodiment, the terminal may determine, in a case where the reference signal overlaps with the first time window in at least one symbol, that the time domain for the reference signal conflicts with the time domain for the other information. The starting location of the first time window is at the X1 symbols or slots before the other information. The ending location of the first time window is at the Y1 symbols or slots after the other information.

For instance, the first time window may be pre-defined. The starting location of the first time window is at the X1 symbols or slots before the other information. The ending location of the first time window is at the Y1 symbols or slots after the other information. That is, the first time window includes the X1 symbols or slots before the other information, symbols where the other information is located, and the Y1 symbols or slots after the other information. The terminal may determine, in a case where at least one of the PRS or the SRS overlaps with the first time window in at least one symbol, that the time domain for the reference signal conflicts with the time domain for the other information. This conflict determination mode may be referred to as a conflict criterion 3.

In one embodiment, the terminal may determine, in a case where the second time window overlaps with the other information in at least one symbol, that the time domain for the reference signal conflicts with the time domain for the other information. The starting location of the second time window is at the X2 symbols or slots before the reference signal. The ending location of the second time window is at the Y2 symbols or slots after the reference signal.

For instance, the second time window may be pre-defined. The starting location of the second time window is at the X2 symbols or slots before the reference signal. The ending location of the second time window is at the Y2 symbols or slots after the reference signal. That is, the second time window includes the X2 symbols or slots before the reference signal, symbols where the reference signal is located, and the Y2 symbols or slots after the reference signal. The terminal may determine, in a case where the other information overlaps with the second time window in at least one symbol, that the time domain for the reference signal conflicts with the time domain for the other information. This conflict determination mode may be referred to as a conflict criterion 4.

In one embodiment, X1 and X2 may be identical or not. Y1 and Y2 may be identical or not. The reference signal processing window may include at least one symbol of at least one of the first time window or the second time window. Values of X1, X2, Y1 and Y2 may be integers greater than or equal to 0.

The present disclosure provides various conflict determination modes, such that the terminal processes the reference signal within the reference signal processing window based on the conflict between the time domain for the reference signal and the time domain for the other information. In this way, power consumption caused by terminal positioning is reduced.

In the communication method according to the embodiment of the present disclosure, in a case where the terminal transmits the reference signal on a bandwidth other than the initial BWP, it is determined that the time domain for the reference signal conflicts with the time domain for the other information in at least one of the following ways: determining that the time domain for the reference signal conflicts with a time domain for fourth other information, in a case where third other information is at M symbols before a starting location of the reference signal processing window and the fourth other information is within the reference signal processing window, where M is less than a second threshold, the other information includes the third other information and the fourth other information, and the third other information is configured to indicate a location of the time domain for the fourth other information; determining that the time domain for the reference signal conflicts with the time domain for the other information, in a case where the reference signal overlaps with a third time window in at least one symbol, where a starting location of the third time window is at X3 symbols or slots before the other information, and an ending location of the third time window is at Y3 symbols or slots after the other information; or determining that the time domain for the reference signal conflicts with the time domain for the other information, in a case where a fourth time window overlaps with the other information in at least one symbol, where a starting location of the fourth time window is at X4 symbols or slots before the reference signal, an ending location of the fourth time window is at Y4 symbols or slots after the reference signal, X3 and X4 may be identical or not, Y3 and Y4 may be identical or not, and the reference signal processing window includes at least one symbol of at least one of the third time window or the fourth time window.

In one embodiment, the initial BWP may include at least one of the initial DL BWP and the initial UL BWP. It may be understood that the terminal may receive or not receive a PRS on the initial DL BWP, and the terminal may transmit or not transmit an SRS on the initial UL BWP.

In one embodiment, the terminal may determine, in a case where the third other information is at the M symbols before the starting location of the reference signal processing window and the fourth other information is within the reference signal processing window, that the time domain for the reference signal conflicts with the time domain for the fourth other information. M is less than the second threshold. The other information includes the third other information and the fourth other information. The third other information is configured to indicate a location of the time domain for the fourth other information.

For instance, the terminal receives the third other information at the M symbols before the starting location of the reference signal processing window. The third other information is configured to indicate the location of the time domain for the fourth other information, and the fourth other information is within the reference signal processing window. The terminal may determine that the time domain for the reference signal conflicts with the time domain for the fourth other information. This conflict determination mode may be referred to as a conflict criterion 5.

It may be understood that the second threshold may be preset. In this case, after the terminal receives the third other information at the M symbols before the starting location of the reference signal processing window, the terminal does not have enough time to analyze the third other information, such that the terminal cannot obtain a location of the fourth other information. Thus, the terminal determines that the time domain for the reference signal conflicts with the time domain for the fourth other information.

In one embodiment, the terminal may determine, in a case where the reference signal overlaps with the third time window in at least one symbol, that the time domain for the reference signal conflicts with the time domain for the other information. The starting location of the third time window is at the X3 symbols or slots before the other information. The ending location of the third time window is at the Y3 symbols or slots after the other information.

For instance, the third time window may be pre-defined. The starting location of the third time window is at the X3 symbols or slots before the other information. The ending location of the third time window is at the Y3 symbols or slots after the other information. That is, the third time window includes the X3 symbols or slots before the other information, symbols where the other information is located, and the Y3 symbols or slots after the other information. The terminal may determine, in a case where at least one of the PRS or the SRS overlaps with the third time window in at least one symbol, that the time domain for the reference signal conflicts with the time domain for the other information. This conflict determination mode may be referred to as a conflict criterion 6.

In one embodiment, the terminal may determine, in a case where the fourth time window overlaps with the other information in at least one symbol, that the time domain for the reference signal conflicts with the time domain for the other information. The starting location of the fourth time window is at the X4 symbols or slots before the reference signal. The ending location of the fourth time window is at the Y4 symbols or slots after the reference signal.

For instance, the fourth time window may be pre-defined. The starting location of the fourth time window is at the X4 symbols or slots before the reference signal. The ending location of the fourth time window is at the Y4 symbols or slots after the reference signal. That is, the fourth time window includes the X4 symbols or slots before the reference signal, symbols where the reference signal is located, and the Y4 symbols or slots after the reference signal. The terminal may determine, in a case where the other information overlaps with the fourth time window in at least one symbol, that the time domain for the reference signal conflicts with the time domain for the other information. This conflict determination mode may be referred to as a conflict criterion 7.

In one embodiment, X3 and X4 may be identical or not. Y3 and Y4 may be identical or not. The reference signal processing window may include at least one symbol of at least one of the third time window or the fourth time window. Values of X3, X4, Y3 and Y4 may be integers greater than or equal to 0.

The present disclosure provides various conflict determination modes, such that the terminal processes the reference signal within the reference signal processing window based on the conflict between the time domain for the reference signal and the time domain for the other information. In this way, power consumption caused by terminal positioning is reduced.

In the communication method according to the embodiment of the present disclosure, FIG. 4 is a flowchart of yet another communication method according to an example. As shown in FIG. 4, in a case where the time domain for the reference signal conflicts with the time domain for the second other information, the step that the reference signal is processed in step S21 may include the following step S31.

In step S31, the reference signal is transmitted.

In some embodiments, the terminal transmits the reference signal within the initial BWP, and in a case where the time domain for the reference signal conflicts with the time domain for the second other information, the terminal may transmit the reference signal.

For instance, the terminal transmits the reference signal within the initial BWP. In a case where the time domain for the reference signal conflicts with the time domain for the second other information, the terminal transmits the reference signal, and the terminal does not transmit at least one of other channel or other signal of at least one of the serving cell or the neighboring cell on all component carriers (CCs).

For instance, the terminal transmits the reference signal within the initial BWP. In a case where the time domain for the reference signal conflicts with the time domain for the second other information, the terminal transmits the reference signal, and the terminal transmits at least one of other channel or other signal of at least one of the serving cell or the neighboring cell on CCs other than a designated CC. The designated CC is a CC where the reference signal is located.

It may be understood that the terminal transmits the reference signal within the initial BWP, and in a case where the time domain for the reference signal conflicts with the time domain for the second other information, the terminal transmits the reference signal. At least one of the other channel or the other signal may be transmitted or not be transmitted by the terminal.

In the present disclosure, in a scenario where the terminal transmits the reference signal within the initial BWP, in a case where the time domain for the reference signal conflicts with the time domain for the second other information, the terminal transmits the reference signal. Power consumption caused by terminal positioning can be reduced.

In the communication method according to the embodiment of the present disclosure, FIG. 5 is a flowchart of yet another communication method according to an example. As shown in FIG. 5, in a case where the time domain for the reference signal conflicts with the time domain for the fourth other information, the step that the reference signal is processed may include the following step S41.

In step S41, the reference signal is transmitted.

In some embodiments, the terminal transmits the reference signal on a bandwidth other than the initial BWP, and in a case where the time domain for the reference signal conflicts with the time domain for the fourth other information, the terminal may transmit the reference signal.

For instance, the terminal transmits the reference signal on a bandwidth other than the initial BWP. In a case where the time domain for the reference signal conflicts with the time domain for the fourth other information, the terminal transmits the reference signal, and the terminal does not transmit at least one of other channel or other signal of at least one of the serving cell or the neighboring cell on all CCs.

For instance, the terminal transmits the reference signal on a bandwidth other than the initial BWP. In a case where the time domain for the reference signal conflicts with the time domain for the fourth other information, the terminal transmits the reference signal, and the terminal transmits at least one of other channel or other signal of at least one of the serving cell or the neighboring cell on CCs other than a designated CC. The designated CC is a CC where the reference signal is located.

It may be understood that the terminal transmits the reference signal on a bandwidth other than the initial BWP, and in a case where the time domain for the reference signal conflicts with the time domain for the fourth other information, the terminal transmits the reference signal. At least one of the other channel or the other signal may be transmitted or not be transmitted by the terminal.

In the present disclosure, in a scenario where the terminal transmits the reference signal on a bandwidth other than the initial BWP, in a case where the time domain for the reference signal conflicts with the time domain for the fourth other information, the terminal transmits the reference signal. Power consumption caused by terminal positioning can be reduced.

In the communication method according to the embodiment of the present disclosure, FIG. 6 is a flowchart of yet another communication method according to an example. As shown in FIG. 6, the step that the reference signal is processed in at least one of step S13 or step S21 may include the following step S51.

In step S51, information having highest priority among the reference signal and the other information is transmitted based on a priority rule.

In some embodiments, the terminal may determine and transmit the information having the highest priority among the reference signal and the other information based on the priority rule.

The priority rule may be preset or specified in a protocol.

According to the present disclosure, the information having the highest priority may be transmitted within the corresponding reference signal processing window based on the priority rule, and power consumption caused by terminal positioning can be reduced.

In the communication method according to the embodiment of the present disclosure, the priority rule includes: at least one of priority of the reference signal being higher than priority of at least one of a channel or a signal of the serving cell, or priority of the reference signal being higher than priority of at least one of a channel or a signal of the neighboring cell; or at least one of priority of the reference signal being lower than priority of at least one of a channel or a signal of the serving cell, or priority of the reference signal being lower than priority of at least one of a channel or a signal of the neighboring cell.

In some embodiments, the priority rule may include the priority of the reference signal being higher than the priority of at least one of the channel or the signal of the serving cell.

For instance, the priority rule may include at least one of: the priority of the reference signal being higher than the priority of the channel of the serving cell, the priority of the reference signal being higher than the priority of the signal of the serving cell, or the priority of the reference signal being higher than the priority of the channel and the signal of the serving cell.

In some embodiments, the priority rule may include: the priority of the reference signal being lower than the priority of at least one of the channel or the signal of the serving cell.

For instance, the priority rule may include at least one of: the priority of the reference signal being lower than the priority of the channel of the serving cell, the priority of the reference signal being lower than the priority of the signal of the serving cell, or the priority of the reference signal being lower than the priority of the channel and the signal of the serving cell.

In some embodiments, the priority rule may include: the priority of the reference signal being higher than the priority of at least one of the channel or the signal of the neighboring cell.

For instance, the priority rule may include at least one of: the priority of the reference signal being higher than the priority of the channel of the neighboring cell, the priority of the reference signal being higher than the priority of the signal of the neighboring cell, or the priority of the reference signal being higher than the priority of the channel and the signal of the neighboring cell.

The present disclosure provides various priority rules, such that the terminal may transmit the information having the highest priority within the corresponding reference signal processing window, and power consumption caused by terminal positioning can be reduced.

In the communication method according to the embodiment of the present disclosure, in a case where the priority of the reference signal is higher than the priority of at least one of the channel or the signal of the serving cell, the step that the information having the highest priority among the reference signal and the other information is transmitted in step S51 may include: transmitting the reference signal; or, transmitting the reference signal and at least one of a channel or a signal of the serving cell on other CCs except a designated CC. The designated CC is a CC where the reference signal is located.

In some embodiments, in a case where the priority rule is that the priority of the reference signal is higher than the priority of at least one of the channel or the signal of the serving cell, the terminal may transmit the reference signal. In this case, the terminal does not transmit at least one of a channel or a signal of the serving cell on all CCs.

In some embodiments, in a case where the priority rule is that the priority of the reference signal is higher than the priority of at least one of the channel or the signal of the serving cell, the terminal may transmit the reference signal, and the terminal may further transmit at least one of a channel or a signal of the serving cell on the other CCs except the designated CC. The designated CC is a CC where the reference signal is located. It may be understood that, in this case, the terminal only does not transmit at least one of a channel or a signal of the serving cell on the CC where the reference signal is located, and may still transmit at least one of the channel or the signal of the serving cell on the other CCs except the designated CC.

In a case where the priority rule is that the priority of the reference signal is higher than the priority of at least one of the channel or the signal of the serving cell, the terminal may only transmit the reference signal, or transmit the reference signal and at least one of the channel or the signal of the serving cells on the other CCs except the designated CC, such that power consumption caused by terminal positioning can be reduced.

In the communication method according to the embodiment of the present disclosure, in a case where the priority of the reference signal is lower than the priority of at least one of the channel or the signal of the serving cell, the step that the information having the highest priority among the reference signal and the other information is transmitted in step S51 includes: the terminal not transmitting the reference signal, and transmitting at least one of the channel or the signal of the serving cell.

In some embodiments, in a case where the priority rule is that the priority of the reference signal is lower than the priority of at least one of the channel or the signal of the serving cell, the terminal may not transmit the reference signal. In this case, the terminal transmits at least one of the channel or the signal of the serving cell on all the CCs.

In a case where the priority rule is that the priority of the reference signal is lower than the priority of at least one of the channel or the signal of the serving cell, the terminal may not transmit the reference signal and may transmit at least one of the channel or the signal of the serving cell, such that power consumption caused by terminal positioning can be reduced.

In the communication method according to the embodiment of the present disclosure, in a case where the priority of the reference signal is higher than the priority of at least one of the channel or the signal of the neighboring cell, the step that the information having the highest priority among the reference signal and the other information is transmitted in step S51 includes: transmitting the reference signal; or, transmitting the reference signal and at least one of other channel or other signal of the neighboring cell on other CCs except a designated CC. The designated CC is a CC where the reference signal is located.

In some embodiments, in a case where the priority rule is that the priority of the reference signal is higher than the priority of at least one of the channel or the signal of the neighboring cell, the terminal may transmit the reference signal. In this case, the terminal does not transmit at least one of a channel or a signal of the neighboring cell on all the CCs.

In some embodiments, in a case where the priority rule is that the priority of the reference signal is higher than the priority of at least one of the channel or the signal of the neighboring cell, the terminal may transmit the reference signal, and the terminal may further transmit at least one of the channel or the signal of the neighboring cell on the other CCs except the designated CC. The designated CC is the CC where the reference signal is located. It may be understood that, in this case, the terminal only does not transmit at least one of a channel or a signal of the neighboring cell on the CC where the reference signal is located, and may still transmit at least one of the channel or the signal of the neighboring cell on the other CCs except the designated CC.

In a case where the priority rule is that the priority of the reference signal is higher than the priority of at least one of the channel or the signal of the neighboring cell, the terminal may only transmit the reference signal, or transmit the reference signal and at least one of the channel or the signal of the neighboring cell on the other CCs except the designated CC, such that power consumption caused by terminal positioning can be reduced.

In the communication method according to the embodiment of the present disclosure, in a case where the priority of the reference signal is lower than the priority of at least one of the channel or the signal of the neighboring cell, the step that the information having the highest priority among the reference signal and the other information is transmitted in step S51 includes: the terminal not transmitting the reference signal, and transmitting at least one of the channel or the signal of the neighboring cell.

In some embodiments, in a case where the priority rule is that the priority of the reference signal is lower than the priority of at least one of the channel or the signal of the neighboring cell, the terminal may not transmit the reference signal. In this case, the terminal transmits at least one of the channel or the signal of the neighboring cell on all the CCs.

In a case where the priority rule is that the priority of the reference signal is lower than the priority of at least one of the channel or the signal of the neighboring cell, the terminal may not transmit the reference signal and may transmit at least one of the channel or the signal of the neighboring cell, such that power consumption caused by terminal positioning can be reduced.

In the communication method according to the embodiment of the present disclosure, FIG. 7 is a flowchart of yet another communication method according to an example. As shown in FIG. 7, the method may further include step S61.

In step S61, terminal capability information is transmitted to a network device.

In some embodiments, the terminal may transmit the terminal capability information to the network device. The terminal capability information includes conflict determination mode indication information. The conflict determination mode indication information is configured to indicate a determination mode for determining that the time domain for the reference signal conflicts with the time domain for the other information.

It may be understood that the conflict determination mode indication information may indicate a mode used by the terminal to determine that the time domain for the reference signal conflicts with the time domain for the other information.

In some embodiments, the network device may be at least one of an LMF network element or a gNB.

The terminal of the present disclosure may further transmit the terminal capability information to the network device, such that the transmission of the reference signal between the network device and the terminal may be performed based on the terminal capability information, and power consumption caused by terminal positioning can be reduced.

In the communication method according to the embodiment of the present disclosure, in a case where the terminal transmits the reference signal within the initial BWP, the terminal capability information further includes at least one of: a value of X1 and a value of Y1; or a value of X2 and a value of Y2.

In some embodiments, in a case where the terminal transmits the reference signal within the initial BWP, the conflict determination mode indication information in the terminal capability information transmitted from the terminal to the network device may indicate that a conflict determination mode is at least one of the conflict criterion 1, the conflict criterion 2, the conflict criterion 3, or the conflict criterion 4.

In some embodiments, in a case of indicating that the conflict determination mode is the conflict criterion 3, the terminal capability information further includes the value of X1 and the value of Y1.

In some embodiments, in a case of indicating that the conflict determination mode is the conflict criterion 4, the terminal capability information further includes the value of X2 and the value of Y2.

The terminal capability information of the present disclosure may further include some parameter values for determination of some conflicts, such that the transmission of the reference signal between the network device and the terminal may be performed based on the terminal capability information, and power consumption caused by terminal positioning can be reduced.

In the communication method according to the embodiment of the present disclosure, the value of X1 and the value of Y1 are determined based on a subcarrier spacing (SCS) of the initial BWP; and the value of X2 and the value of Y2 are determined based on an SCS of the initial BWP.

In some embodiments, the value of X1 and the value of Y1 may be determined based on the SCS of the initial BWP.

For instance, in a case where the terminal transmits the reference signal within an initial UL BWP, the value of X1 and the value of Y1 may be determined based on an SCS of the initial UL BWP. For instance, in a case where the terminal transmits the reference signal within an initial DL BWP, the value of X1 and the value of Y1 may be determined based on an SCS of the initial DL BWP.

In some embodiments, the value of X2 and the value of Y2 may be determined based on the SCS of the initial BWP.

For instance, in a case where the terminal transmits the reference signal within the initial UL BWP, the value of X2 and the value of Y2 may be determined based on the SCS of the initial UL BWP. For instance, in a case where the terminal transmits the reference signal within the initial DL BWP, the value of X2 and the value of Y2 may be determined based on the SCS of the initial DL BWP.

The present disclosure provides a determination mode for some parameters included in the terminal capability information and used for conflict determination, such that the transmission of the reference signal between the network device and the terminal may be performed based on the terminal capability information, and power consumption caused by terminal positioning can be reduced.

In the communication method according to the embodiment of the present disclosure, in a case where the terminal transmits the reference signal on a bandwidth other than the initial BWP, the terminal capability information further includes at least one of: a value of X3 and a value of Y3; or a value of X4 and a value of Y4.

In some embodiments, in a case where the terminal transmits the reference signal on a bandwidth other than the initial BWP, the conflict determination mode indication information in the terminal capability information transmitted from the terminal to the network device may indicate that a conflict determination mode is at least one of the conflict criterion 5, the conflict criterion 6, or the conflict criterion 7.

In some embodiments, in a case of indicating that the conflict determination mode is the conflict criterion 6, the terminal capability information further includes the value of X3 and the value of Y3.

In some embodiments, in a case of indicating that the conflict determination mode is the conflict criterion 7, the terminal capability information further includes the value of X4 and the value of Y4.

The terminal capability information of the present disclosure may further include some parameter values for determination of some conflicts, such that the transmission of the reference signal between the network device and the terminal may be performed based on the terminal capability information, and power consumption caused by terminal positioning can be reduced.

In the communication method according to the embodiment of the present disclosure, the value of X3 and the value of Y3 are determined based on an SCS of the initial BWP, alternatively, the value of X3 and the value of Y3 are determined based on an SCS of a BWP where the reference signal is located. The value of X4 and the value of Y4 are determined based on the SCS of the initial BWP, alternatively, the value of X4 and the value of Y4 are determined based on the SCS of the BWP where the reference signal is located.

In some embodiments, the value of X3 and the value of Y3 may be determined based on the SCS of the initial BWP. Alternatively, the value of X3 and the value of Y3 may be determined based on the SCS of the BWP where the reference signal is located.

For instance, in a case where the terminal transmits the reference signal on a bandwidth other than the initial UL BWP, the value of X3 and the value of Y3 may be determined based on an SCS of the initial UL BWP. For instance, in a case where the terminal transmits the reference signal on a bandwidth other than the initial DL BWP, the value of X3 and the value of Y3 may be determined based on an SCS of the initial DL BWP.

In some embodiments, the value of X4 and the value of Y4 may be determined based on the SCS of the initial BWP. Alternatively, the value of X4 and the value of Y4 may be determined based on the SCS of the BWP where the reference signal is located.

For instance, in a case where the terminal transmits the reference signal on a bandwidth other than the initial UL BWP, the value of X4 and the value of Y4 may be determined based on the SCS of the initial UL BWP. For instance, in a case where the terminal transmits the reference signal on a bandwidth other than the initial DL BWP, the value of X4 and the value of Y4 may be determined based on the SCS of the initial DL BWP.

The present disclosure provides a determination mode for some parameters included in the terminal capability information and used for conflict determination, such that the transmission of the reference signal between the network device and the terminal may be performed based on the terminal capability information, and power consumption caused by terminal positioning can be reduced.

It may be understood that X3 and X4 involved in the present disclosure are greater than or equal to X1 and X2, and Y3 and Y4 involved in the present disclosure are greater than or equal to Y1 and Y2, as a BWP for the reference signal is different from a BWP for the other information in the conflict criterion 6 and the conflict criterion 7. For instance, the other information may be located in the initial BWP all the time. Thus, time for radio frequency (RF) retuning is further required.

In the communication method according to the embodiment of the present disclosure, a configuration parameter for the reference signal processing window is the first configuration parameter or the second configuration parameter. The configuration parameter for the reference signal processing window includes at least one of: a time domain parameter; a frequency domain parameter; or terminal-specific information.

In some embodiments, the configuration parameter for the reference signal processing window may be the first configuration parameter or the second configuration parameter.

In some embodiments, the configuration parameter for the reference signal processing window may include the time domain parameter.

In some embodiments, the configuration parameter for the reference signal processing window may include the frequency domain parameter.

In some embodiments, the configuration parameter for the reference signal processing window may include the terminal-specific information.

For instance, the terminal-specific information may include a terminal identity, a terminal paging occasion, and other terminal-related information.

The present disclosure provides different configuration parameters for the reference signal processing window, such that the reference signal processing window may be determined and configured based on the configuration parameter for the reference signal processing window, the reference signal may be processed within the corresponding reference signal processing window, and further power consumption caused by terminal positioning can be reduced.

Based on an identical concept, the present disclosure further provides a communication method, which is performed at a network device.

FIG. 8 is a flowchart of yet another communication method according to an example. As shown in FIG. 8, the method is performed by a network device. The method may include step S71.

In step S71, in a case where a terminal is in a non-connected state, a first configuration parameter is determined.

In some embodiments, in a case where the terminal is in the non-connected state, the network device may determine the first configuration parameter configured to configure a reference signal processing window. The first configuration parameter is configured to instruct the terminal to determine the reference signal processing window and to process a reference signal based on the reference signal processing window.

For instance, the terminal being in the non-connected state may include that the terminal is in an RRC_INACTIVE state or an RRC_IDLE state.

In some embodiments, a resource corresponding to the reference signal processing window may be used by the terminal to process the reference signal.

In some embodiments, the reference signal may include at least one of a PRS or an SRS.

In some embodiments, the terminal processes the reference signal, for instance, may transmit and/or receive the reference signal, or transmit and/or receive other information. It may be understood that the other information may be any channel except a channel transmitting the reference signal or may be any signal except the reference signal.

In the present disclosure, the first configuration parameter configured to configure the reference signal processing window is determined, such that the terminal processes the reference signal within the corresponding reference signal processing window, and further power consumption caused by terminal positioning is reduced.

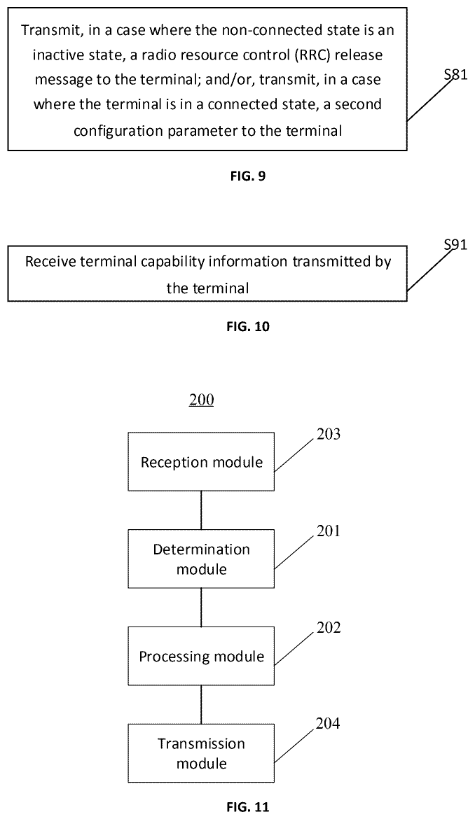

In the communication method according to the embodiment of the present disclosure, FIG. 9 is a flowchart of yet another communication method according to an example. As shown in FIG. 9, the method may further include step S81.

In step S81, in a case where the non-connected state is an inactive state, a first RRC release message is transmitted to the terminal; and/or, in a case where the terminal is in a connected state, a second configuration parameter is transmitted to the terminal.

In some embodiments, in a case where the terminal is in an RRC_INACTIVE state, the network device may transmit the first RRC release message to the terminal. The first RRC release message includes the first configuration parameter.

For instance, in a case where the network device configures the first RRC release message for the terminal, the first configuration parameter may be carried in the first RRC release message.

In some embodiments, in a case where the terminal is in an RRC_CONNECTED state, the network device may transmit the second configuration parameter to the terminal. The second configuration parameter is a configuration parameter configured to configure the reference signal processing window while the terminal is in the RRC_CONNECTED state.

For instance, in a case where the terminal is in the RRC_CONNECTED state, the network device may transmit the second configuration parameter to the terminal. The second configuration parameter is configured to indicate the reference signal processing window in which the terminal processes the reference signal while in the RRC_CONNECTED state.

The present disclosure provides that the network device indicates the reference signal processing window to the terminal in various modes, such that the terminal in various states may process the reference signal within the corresponding reference signal processing window, and further power consumption caused by terminal positioning is reduced.

In the communication method according to the embodiment of the present disclosure, in a case where the non-connected state is an idle state, the method further includes at least one of: transmitting to the terminal a configuration parameter configured to indicate the first configuration parameter, in a case where the network device is a core network device; transmitting to the terminal broadcast information carrying a configuration parameter configured to indicate the first configuration parameter; transmitting a second RRC release message to the terminal; or transmitting to the terminal, in an RA procedure, a configuration parameter configured to indicate the first configuration parameter.

In some embodiments, in a case where the terminal is in an RRC_IDLE state, the network device is a core network. The network device may transmit to the terminal the configuration parameter configured to indicate the first configuration parameter. For instance, the core network device may be an LMF network element.

In some embodiments, in a case where the terminal is in the RRC_IDLE state, the network device may transmit a broadcast message to the terminal. The broadcast message carries the configuration parameter configured to indicate the first configuration parameter.

In some embodiments, in a case where the terminal is in the RRC_IDLE state, the network device may transmit the second RRC release message to the terminal. The second RRC release message includes the first configuration parameter.

For instance, in a case where the network device configures the second RRC release message for the terminal, the first configuration parameter may be carried in the second RRC release message.

In some embodiments, in a case where the terminal is in the RRC_IDLE state, the network device may transmit to the terminal, in the RA procedure, the configuration parameter configured to indicate the first configuration parameter.

For instance, the first configuration parameter may be determined based on an MSG 2 (that is, a random access response), an MSG 4, or an MSG B in the RA procedure. The MSG 2 and the MSG 4 are feedbacks transmitted by an access network device to the terminal in step two and step four respectively in four-step random access procedure. The MSG B is feedback transmitted by the access network device to the terminal in two-step random access procedure.

The present disclosure provides various ways for the network device to configure the reference signal processing window for the terminal in the idle state, such that the terminal may process the reference signal within the corresponding reference signal processing window, and further power consumption caused by terminal positioning is reduced.

In the communication method according to the embodiment of the present disclosure, the first configuration parameter is further configured to instruct, in a case where a time domain for the reference signal conflicts with a time domain for other information, the terminal to process the reference signal. The other information includes at least one of any channel or any signal except the reference signal.

In some embodiments, in a case where the time domain for the reference signal conflicts with the time domain for the other information, the first configuration parameter may be further configured to instruct the terminal to process the reference signal. The other information may include at least one of any channel or any signal except the reference signal.

For instance, the first configuration parameter instructs the terminal to process the reference signal within the reference signal processing window according to locations of the time domain for the reference signal and the time domain for the other information, for example, in a case where the time domain for the reference signal conflicts with the time domain for the other information. For instance, the first configuration parameter instructs the terminal to receive a PRS, not receive a PRS, transmit an SRS, not transmit an SRS, transmit other information, and/or not transmit other information.

In some embodiments, whether the time domain for the reference signal conflicts with the time domain for the other information may be determined according to a conflict criterion preset or specified in a protocol.

In the present disclosure, the reference signal is processed within the reference signal processing window based on a conflict between the time domain for the reference signal and the time domain for the other information. In this way, power consumption caused by terminal positioning is reduced.

In the communication method according to the embodiment of the present disclosure, the other information includes at least one of: at least one of a channel or a signal of a serving cell; or at least one of a channel or a signal of a neighboring cell.

In some embodiments, the other information may include at least one of the channel or the signal of the serving cell.

In some embodiments, the other information may include at least one of the channel or the signal of the neighboring cell.

The present disclosure may be applied to a scenario where a time domain for at least one of the channel or the signal of the serving cell conflicts with the time domain for the reference signal, and may further be applied to a scenario where a time domain for at least one of the channel or the signal of the neighboring cell conflicts with the time domain for the reference signal. Thus, in different scenarios, the terminal may process the reference signal within the corresponding reference signal processing window, and further power consumption caused by terminal positioning is reduced.

In the communication method according to the embodiment of the present disclosure, at least one of the channel or the signal of the serving cell may include at least one of: an SSB of the serving cell; an SIB 1 of the serving cell; a CORESET 0 of the serving cell; a MSG 2 or an MSG B of the serving cell; a paging message of the serving cell; or uplink or downlink SDT of the serving cell.

In some embodiments, at least one of the channel or the signal of the serving cell may include the SSB of the serving cell.

In some embodiments, at least one of the channel or the signal of the serving cell may include the SIB 1 of the serving cell.

In some embodiments, at least one of the channel or the signal of the serving cell may include the CORESET 0 of the serving cell.

The CORESET 0 may be considered as a special CORESET. The CORESET 0 indicates a corresponding resource block obtained by the terminal from a PDCCH-config SIB 1 in a cell search procedure, and a number of symbols corresponding to a type 0-PDCCH CSS set associated with the resource block.

In some embodiments, at least one of the channel or the signal of the serving cell may include the MSG 2 or the MSG B of the serving cell.

In some embodiments, at least one of the channel or the signal of the serving cell may include the paging message of the serving cell.

In some embodiments, at least one of the channel or the signal of the serving cell may include the uplink or downlink SDT of the serving cell.

The present disclosure provides various different channels and/or signals of the serving cells, such that in a scenario where the time domain for at least one of the channel or the signal of the serving cell conflicts with the time domain for the reference signal, the terminal may process the reference signal within the corresponding reference signal processing window, and further power consumption caused by terminal positioning is reduced.

In the communication method according to the embodiment of the present disclosure, at least one of the channel or the signal of the neighboring cell may include at least one of: an SSB of the neighboring cell; an SIB 1 of the neighboring cell; a CSI-RS of the neighboring cell; or a CORESET 0 of the neighboring cell.

In some embodiments, at least one of the channel or the signal of the neighboring cell may include the SSB of the neighboring cell.

In some embodiments, at least one of the channel or the signal of the neighboring cell may include the SIB 1 of the neighboring cell.

In some embodiments, at least one of the channel or the signal of the neighboring cell may include the CSI-RS of the neighboring cell.

In some embodiments, at least one of the channel or the signal of the neighboring cell may include the CORESET 0 of the neighboring cell.

The present disclosure provides various different channels and/or signals of the neighboring cells, such that in a scenario where the time domain for at least one of the channel or the signal of the neighboring cell conflicts with the time domain for the reference signal, the terminal may process the reference signal within the corresponding reference signal processing window, and further power consumption caused by terminal positioning is reduced.

In the communication method according to the embodiment of the present disclosure, in a case where the transmission of the reference signal between the network device and the terminal is performed within the initial BWP, it is determined that the time domain for the reference signal conflicts with the time domain for the other information in at least one of the following ways: determining that the time domain for the reference signal conflicts with the time domain for the other information, in a case where the reference signal overlaps with the other information in at least one symbol; determining that the time domain for the reference signal conflicts with a time domain for second other information, in a case where first other information is at N symbols before a starting location of the reference signal processing window and the second other information is within the reference signal processing window, where N is less than a first threshold, the other information includes the first other information and the second other information, and the first other information is configured to indicate a location of the time domain for the second other information; determining that the time domain for the reference signal conflicts with the time domain for the other information, in a case where the reference signal overlaps with a first time window in at least one symbol, where a starting location of the first time window is at X1 symbols or slots before the other information, and an ending location of the first time window is at Y1 symbols or slots after the other information; or determining that the time domain for the reference signal conflicts with the time domain for the other information, in a case where a second time window overlaps with the other information in at least one symbol, where a starting location of the second time window is at X2 symbols or slots before the reference signal, an ending location of the second time window is at Y2 symbols or slots after the reference signal, X1 and X2 may be identical or not, Y1 and Y2 may be identical or not, and the reference signal processing window includes at least one symbol of at least one of the first time window or the second time window.

In one embodiment, the initial BWP may include at least one of an initial DL BWP and an initial UL BWP. It may be understood that the network device may transmit or not transmit a PRS on the initial DL BWP, and the network device may receive or not receive an SRS on the initial UL BWP.

In one embodiment, in a case where the reference signal overlaps with the other information in at least one symbol, it is determined that the time domain for the reference signal conflicts with the time domain for the other information.

For instance, in a case where at least one of the PRS or the SRS overlaps with the other information in at least one symbol, it is determined that the time domain for the reference signal conflicts with the time domain for the other information. This conflict determination mode may be referred to as a conflict criterion 1.

In one embodiment, in a case where the first other information is at the N symbols before the starting location of the reference signal processing window and the second other information is within the reference signal processing window, it is determined that the time domain for the reference signal conflicts with the time domain for the second other information. N is less than the first threshold. The other information includes the first other information and the second other information. The first other information is configured to indicate the location of the time domain for the second other information.

For instance, the first other information is at the N symbols before the starting location of the reference signal processing window. The first other information is configured to indicate the location of the time domain for the second other information, and the second other information is within the reference signal processing window. It may be determined that the time domain for the reference signal conflicts with the time domain for the second other information. This conflict determination mode may be referred to as a conflict criterion 2.

It may be understood that the first threshold may be preset.

In one embodiment, in a case where the reference signal overlaps with the first time window in at least one symbol, it is determined that the time domain for the reference signal conflicts with the time domain for the other information. The starting location of the first time window is at the X1 symbols or slots before the other information. The ending location of the first time window is at the Y1 symbols or slots after the other information.

For instance, the first time window may be pre-defined. The starting location of the first time window is at the X1 symbols or slots before the other information. The ending location of the first time window is at the Y1 symbols or slots after the other information. That is, the first time window includes the X1 symbols or slots before the other information, symbols where the other information is located, and the Y1 symbols or slots after the other information. In a case where at least one of the PRS or the SRS overlaps with the first time window in at least one symbol, it may be determined that the time domain for the reference signal conflicts with the time domain for the other information. This conflict determination mode may be referred to as a conflict criterion 3.

In one embodiment, in a case where the second time window overlaps with the other information in at least one symbol, it is determined that the time domain for the reference signal conflicts with the time domain for the other information. The starting location of the second time window is at the X2 symbols or slots before the reference signal. The ending location of the second time window is at the Y2 symbols or slots after the reference signal.

For instance, the second time window may be pre-defined. The starting location of the second time window is at the X2 symbols or slots before the reference signal. The ending location of the second time window is at the Y2 symbols or slots after the reference signal. That is, the second time window includes the X2 symbols or slots before the reference signal, symbols where the reference signal is located, and the Y2 symbols or slots after the reference signal. In a case where the other information overlaps with the second time window in at least one symbol, it may be determined that the time domain for the reference signal conflicts with the time domain for the other information. This conflict determination mode may be referred to as a conflict criterion 4.

In one embodiment, X1 and X2 may be identical or not. Y1 and Y2 may be identical or not. The reference signal processing window may include at least one symbol of at least one of the first time window or the second time window. Values of X1, X2, Y1 and Y2 may be integers greater than or equal to 0.

The present disclosure provides various conflict determination modes, such that the terminal processes the reference signal within the reference signal processing window based on the conflict between the time domain for the reference signal and the time domain for the other information. In this way, power consumption caused by terminal positioning is reduced.

In the communication method according to the embodiment of the present disclosure, in a case where the transmission of the reference signal between the network device and the terminal is performed on a bandwidth other than the initial BWP, it is determined that the time domain for the reference signal conflicts with the time domain for the other information in at least one of the following ways: determining that the time domain for the reference signal conflicts with a time domain for fourth other information, in a case where third other information is at M symbols before a starting location of the reference signal processing window and the fourth other information is within the reference signal processing window, where M is less than a second threshold, the other information includes the third other information and the fourth other information, and the third other information is configured to indicate a location of the time domain for the fourth other information; determining that the time domain for the reference signal conflicts with the time domain for the other information, in a case where the reference signal overlaps with a third time window in at least one symbol, where a starting location of the third time window is at X3 symbols or slots before the other information, and an ending location of the third time window is at Y3 symbols or slots after the other information; or determining that the time domain for the reference signal conflicts with the time domain for the other information, in a case where a fourth time window overlaps with the other information in at least one symbol, where a starting location of the fourth time window is at X4 symbols or slots before the reference signal, an ending location of the fourth time window is at Y4 symbols or slots after the reference signal, X3 and X4 may be identical or not, Y3 and Y4 may be identical or not, and the reference signal processing window includes at least one symbol of at least one of the third time window or the fourth time window.

In one embodiment, the initial BWP may include at least one of the initial DL BWP and the initial UL BWP. It may be understood that the network device may transmit or not transmit a PRS on the initial DL BWP, and the network device may receive or not receive an SRS on the initial UL BWP.

In one embodiment, in a case where the third other information is at the M symbols before the starting location of the reference signal processing window and the fourth other information is within the reference signal processing window, it is determined that the time domain for the reference signal conflicts with the time domain for the fourth other information. M is less than the second threshold. The other information includes the third other information and the fourth other information. The third other information is configured to indicate the location of the time domain for the fourth other information.

For instance, the third other information is at the M symbols before the starting location of the reference signal processing window. The third other information is configured to indicate the location of the time domain for the fourth other information, and the fourth other information is within the reference signal processing window. It may be determined that the time domain for the reference signal conflicts with the time domain for the fourth other information. This conflict determination mode may be referred to as a conflict criterion 5.

It may be understood that the second threshold may be preset.

In one embodiment, in a case where the reference signal overlaps with the third time window in at least one symbol, it is determined that the time domain for the reference signal conflicts with the time domain for the other information. The starting location of the third time window is at the X3 symbols or slots before the other information. The ending location of the third time window is at the Y3 symbols or slots after the other information.

For instance, the third time window may be pre-defined. The starting location of the third time window is at the X3 symbols or slots before the other information. The ending location of the third time window is at the Y3 symbols or slots after the other information. That is, the third time window includes the X3 symbols or slots before the other information, symbols where the other information is located, and the Y3 symbols or slots after the other information. In a case where at least one of the PRS or the SRS overlaps with the third time window in at least one symbol, it may be determined that the time domain for the reference signal conflicts with the time domain for the other information. This conflict determination mode may be referred to as a conflict criterion 6.

In one embodiment, in a case where the fourth time window overlaps with the other information in at least one symbol, it is determined that the time domain for the reference signal conflicts with the time domain for the other information. The starting location of the fourth time window is at the X4 symbols or slots before the reference signal. The ending location of the fourth time window is at the Y4 symbols or slots after the reference signal.

For instance, the fourth time window may be pre-defined. The starting location of the fourth time window is at the X4 symbols or slots before the reference signal. The ending location of the fourth time window is at the Y4 symbols or slots after the reference signal. That is, the fourth time window includes the X4 symbols or slots before the reference signal, symbols where the reference signal is located, and the Y4 symbols or slots after the reference signal. In a case where the other information overlaps with the fourth time window in at least one symbol, it may be determined that the time domain for the reference signal conflicts with the time domain for the other information. This conflict determination mode may be referred to as a conflict criterion 7.

In one embodiment, X3 and X4 may be identical or not. Y3 and Y4 may be identical or not. The reference signal processing window may include at least one symbol of at least one of the third time window or the fourth time window. Values of X3, X4, Y3 and Y4 may be integers greater than or equal to 0.

The present disclosure provides various conflict determination modes, such that the terminal processes the reference signal within the reference signal processing window based on the conflict between the time domain for the reference signal and the time domain for the other information. In this way, power consumption caused by terminal positioning is reduced.

In the communication method according to the embodiment of the present disclosure, in a case where the time domain for the reference signal conflicts with the time domain for the second other information, the first configuration parameter is further configured to instruct the terminal to transmit the reference signal.

In some embodiments, the transmission of the reference signal between the network device and the terminal is performed within the initial BWP, and in a case where the time domain for the reference signal conflicts with the time domain for the second other information, the first configuration parameter is further configured to instruct the terminal to transmit the reference signal.

For instance, the transmission of the reference signal between the network device and the terminal is performed within the initial BWP. In a case where the time domain for the reference signal conflicts with the time domain for the second other information, the first configuration parameter is further configured to instruct the terminal to transmit the reference signal, and to instruct the terminal not to transmit at least one of other channel or other signal of at least one of the serving cell or the neighboring cell on all CCs.

For instance, the transmission of the reference signal between the network device and the terminal is performed within the initial BWP. In a case where the time domain for the reference signal conflicts with the time domain for the second other information, the first configuration parameter is further configured to instruct the terminal to transmit the reference signal, and to instruct the terminal to transmit at least one of other channel or other signal of at least one of the serving cell or the neighboring cell on CCs other than a designated CC. The designated CC is a CC where the reference signal is located.

It may be understood that the transmission of the reference signal between the network device and the terminal is performed within the initial BWP, and in a case where the time domain for the reference signal conflicts with the time domain for the second other information, the first configuration parameter is further configured to instruct the terminal to transmit the reference signal. The first configuration parameter may be further configured to instruct the terminal to transmit at least one of other channel or other signal, or not to transmit at least one of other channel or other signal.

According to the present disclosure, in a scenario where the transmission of the reference signal between the network device and the terminal is performed within the initial BWP, in a case where the time domain for the reference signal conflicts with the time domain for the second other information, the first configuration parameter instructs the terminal to transmit the reference signal. Power consumption caused by terminal positioning can be reduced.

In the communication method according to the embodiment of the present disclosure, in a case where the time domain for the reference signal conflicts with the time domain for the fourth other information, the first configuration parameter is further configured to instruct the terminal to transmit the reference signal.

In some embodiments, the transmission of the reference signal between the network device and the terminal is performed on a bandwidth other than the initial BWP, and in a case where the time domain for the reference signal conflicts with the time domain for the fourth other information, the first configuration parameter is further configured to instruct the terminal to transmit the reference signal.

For instance, the transmission of the reference signal between the network device and the terminal is performed on a bandwidth other than the initial BWP. In a case where the time domain for the reference signal conflicts with the time domain for the fourth other information, the first configuration parameter is further configured to instruct the terminal to transmit the reference signal, and to instruct the terminal not to transmit at least one of other channel or other signal of at least one of the serving cell or the neighboring cell on all CCs.

For instance, the transmission of the reference signal between the network device and the terminal is performed on a bandwidth other than the initial BWP. In a case where the time domain for the reference signal conflicts with the time domain for the fourth other information, the first configuration parameter is further configured to instruct the terminal to transmit the reference signal, and to instruct the terminal to transmit at least one of other channel or other signal of at least one of the serving cell or the neighboring cell on CCs other than a designated CC. The designated CC is a CC where the reference signal is located.

It may be understood that the transmission of the reference signal between the network device and the terminal is performed on a bandwidth other than the initial BWP, and in a case where the time domain for the reference signal conflicts with the time domain for the fourth other information, the first configuration parameter is further configured to instruct the terminal to transmit the reference signal. The first configuration parameter may be further configured to instruct the terminal to transmit at least one of other channel or other signal, or not to transmit at least one of other channel or other signal.

In the present disclosure, in a scenario where the transmission of the reference signal between the network device and the terminal is performed on a bandwidth other than the initial BWP, in a case where the time domain for the reference signal conflicts with the time domain for the fourth other information, the first configuration parameter instructs the terminal to transmit the reference signal. Power consumption caused by terminal positioning can be reduced.

In the communication method according to the embodiment of the present disclosure, the first configuration parameter is further configured to instruct the terminal to transmit information having highest priority among the reference signal and the other information based on a priority rule.

In some embodiments, the first configuration parameter is further configured to instruct the terminal to determine and transmit the information having the highest priority among the reference signal and the other information based on the priority rule.

The priority rule may be preset or specified in a protocol.

According to the present disclosure, the information having the highest priority may be transmitted within the corresponding reference signal processing window based on the priority rule, and power consumption caused by terminal positioning can be reduced.

In the communication method according to the embodiment of the present disclosure, the priority rule includes: at least one of priority of the reference signal being higher than priority of at least one of a channel or a signal of the serving cell, or priority of the reference signal being higher than priority of at least one of a channel or a signal of the neighboring cell; or at least one of priority of the reference signal being lower than priority of at least one of a channel or a signal of the serving cell, or priority of the reference signal being lower than priority of at least one of a channel or a signal of the neighboring cell.

In some embodiments, the priority rule may include the priority of the reference signal being higher than the priority of at least one of the channel or the signal of the serving cell.

For instance, the priority rule may include at least one of: the priority of the reference signal being higher than the priority of the channel of the serving cell, the priority of the reference signal being higher than the priority of the signal of the serving cell, or the priority of the reference signal being higher than the priority of the channel and the signal of the serving cell.

In some embodiments, the priority rule may include the priority of the reference signal being lower than the priority of at least one of the channel or the signal of the serving cell.

For instance, the priority rule may include at least one of: the priority of the reference signal being lower than the priority of the channel of the serving cell, the priority of the reference signal being lower than the priority of the signal of the serving cell, or the priority of the reference signal being lower than the priority of the channel and the signal of the serving cell.

In some embodiments, the priority rule may include the priority of the reference signal being higher than the priority of at least one of the channel or the signal of the neighboring cell.

For instance, the priority rule may include at least one of: the priority of the reference signal being higher than the priority of the channel of the neighboring cell, the priority of the reference signal being higher than the priority of the signal of the neighboring cell, or the priority of the reference signal being higher than the priority of the channel and the signal of the neighboring cell.

The present disclosure provides various priority rules, such that the terminal may transmit the information having the highest priority within the corresponding reference signal processing window, and power consumption caused by terminal positioning can be reduced.

In the communication method according to the embodiment of the present disclosure, in a case where the priority of the reference signal is higher than the priority of at least one of the channel or the signal of the serving cell, the first configuration parameter is further configured to instruct the terminal to transmit the reference signal; or to instruct the terminal to transmit the reference signal and at least one of a channel or a signal of the serving cell on other CCs except a designated CC. The designated CC is a CC where the reference signal is located.

In some embodiments, in a case where the priority rule is that the priority of the reference signal is higher than the priority of at least one of the channel or the signal of the serving cell, the first configuration parameter is further configured to instruct the terminal to transmit the reference signal. In this case, the first configuration parameter is further configured to instruct the terminal not to transmit at least one of a channel or a signal of the serving cell on all CCs.

In some embodiments, in a case where the priority rule is that the priority of the reference signal is higher than the priority of at least one of the channel or the signal of the serving cell, the first configuration parameter is further configured to instruct the terminal to transmit the reference signal, and to instruct the terminal to transmit at least one of a channel or a signal of the serving cell on other CCs except a designated CC. The designated CC is a CC where the reference signal is located. It may be understood that, in this case, the first configuration parameter is configured to only instruct the terminal not to transmit at least one of the channel or the signal of the serving cell on the CC where the reference signal is located, and still to transmit at least one of the channel or the signal of the serving cell on the other CCs except the designated CC.

According to the present disclosure, in a case where the priority rule is that the priority of the reference signal is higher than the priority of at least one of the channel or the signal of the serving cell, the first configuration parameter may indicate only transmission of the reference signal, or transmission of the reference signal and at least one of the channel or the signal of the serving cell on the other CCs except the designated CC, such that power consumption caused by terminal positioning can be reduced.

In the communication method according to the embodiment of the present disclosure, in a case where the priority of the reference signal is lower than the priority of at least one of the channel or the signal of the serving cell, the first configuration parameter is further configured to instruct the terminal not to transmit the reference signal, and to instruct the terminal to transmit at least one of the channel or the signal of the serving cell.

In some embodiments, in a case where the priority rule is that the priority of the reference signal is lower than the priority of at least one of the channel or the signal of the serving cell, the first configuration parameter is further configured to instruct the terminal not to transmit the reference signal. In this case, the first configuration parameter is further configured to instruct the terminal to transmit at least one of the channel or the signal of the serving cell on all the CCs.

In a case where the priority rule is that the priority of the reference signal is lower than the priority of at least one of the channel or the signal of the serving cell, it may not transmit the reference signal and may transmit at least one of the channel or the signal of the serving cell, such that power consumption caused by terminal positioning can be reduced.

In the communication method according to the embodiment of the present disclosure, in a case where the priority of the reference signal is higher than the priority of at least one of the channel or the signal of the neighboring cell, the first configuration parameter is further configured to instruct the terminal to transmit the reference signal; or to instruct the terminal to transmit the reference signal and at least one of other channel or other signal of the neighboring cells on other CCs except a designated CC. The designated CC is a CC where the reference signal is located.

In some embodiments, in a case where the priority rule is that the priority of the reference signal is higher than the priority of at least one of the channel or the signal of the neighboring cell, the first configuration parameter is further configured to instruct the terminal to transmit the reference signal. In this case, the first configuration parameter is further configured to instruct the terminal not to transmit at least one of a channel or a signal of the neighboring cell on all the CCs.

In some embodiments, in a case where the priority rule is that the priority of the reference signal is higher than the priority of at least one of the channel or the signal of the neighboring cell, the first configuration parameter is further configured to instruct the terminal to transmit the reference signal, and to instruct the terminal to transmit at least one of the channel or the signal of the neighboring cell on the other CCs except the designated CC. The designated CC is the CC where the reference signal is located. It may be understood that, in this case, the first configuration parameter only instructs the terminal not to transmit at least one of a channel or a signal of the neighboring cell on the CC where the reference signal is located, and instructs the terminal still to transmit at least one of the channel or the signal of the neighboring cell on the other CCs except the designated CC.

According to the present disclosure, in a case where the priority rule is that the priority of the reference signal is higher than the priority of at least one of the channel or the signal of the neighboring cell, the first configuration parameter may indicate only transmission of the reference signal, or transmission of the reference signal and at least one of the channel or the signal of the neighboring cell on the other CCs except the designated CC, such that power consumption caused by terminal positioning can be reduced.

In the communication method according to the embodiment of the present disclosure, in a case where the priority of the reference signal is lower than the priority of at least one of the channel or the signal of the neighboring cell, the first configuration parameter is further configured to instruct the terminal not to transmit the reference signal, and to instruct the terminal to transmit at least one of the channel or the signal of the neighboring cell.

In some embodiments, in a case where the priority rule is that the priority of the reference signal is lower than the priority of at least one of the channel or the signal of the neighboring cell, the first configuration parameter is further configured to instruct the terminal not to transmit the reference signal. In this case, the first configuration parameter is further configured to instruct the terminal to transmit at least one of the channel or the signal of the neighboring cell on all the CCs.

In a case where the priority rule is that the priority of the reference signal is lower than the priority of at least one of the channel or the signal of the neighboring cell, it may not transmit the reference signal and may transmit at least one of the channel or the signal of the neighboring cell, such that power consumption caused by terminal positioning can be reduced.

In the communication method according to the embodiment of the present disclosure, FIG. 10 is a flowchart of still another communication method according to an example. As shown in FIG. 10, the method may further include step S91.

In step S91, terminal capability information transmitted by the terminal is received.

In some embodiments, the network device may receive the terminal capability information transmitted by the terminal. The terminal capability information includes conflict determination mode indication information. The conflict determination mode indication information is configured to indicate a determination mode used by the terminal to determine that the time domain for the reference signal conflicts with the time domain for the other information.

It may be understood that the conflict determination mode indication information may indicate a mode used by the terminal to determine that the time domain for the reference signal conflicts with the time domain for the other information.

In some embodiments, the network device may be at least one of an LMF network element or a gNB.

The network device of the present disclosure may further receive the terminal capability information transmitted by the terminal, such that the transmission of the reference signal between the network device and the terminal may be performed based on the terminal capability information, and power consumption caused by terminal positioning can be reduced.

In the communication method according to the embodiment of the present disclosure, in a case where the transmission of the reference signal between the network device and the terminal is performed within the initial BWP, the terminal capability information further includes at least one of: a value of X1 and a value of Y1; or a value of X2 and a value of Y2.

In some embodiments, in a case where the transmission of the reference signal between the network device and the terminal is performed within the initial BWP, the conflict determination mode indication information in the terminal capability information received by the network device from the terminal may indicate that a conflict determination mode is at least one of the conflict criterion 1, the conflict criterion 2, the conflict criterion 3, or the conflict criterion 4.

In some embodiments, in a case of indicating that the conflict determination mode is the conflict criterion 3, the terminal capability information further includes the value of X1 and the value of Y1.

In some embodiments, in a case of indicating that the conflict determination mode is the conflict criterion 4, the terminal capability information further includes the value of X2 and the value of Y2.

The terminal capability information of the present disclosure may further include some parameter values for determination of some conflicts, such that the transmission of the reference signal between the network device and the terminal may be performed based on the terminal capability information, and power consumption caused by terminal positioning can be reduced.

In the communication method according to the embodiment of the present disclosure, the value of X1 and the value of Y1 are determined based on an SCS of the initial BWP; and the value of X2 and the value of Y2 are determined based on the SCS of the initial BWP.

In some embodiments, the value of X1 and the value of Y1 may be determined based on the SCS of the initial BWP.

For instance, in a case where the transmission of the reference signal between the network device and the terminal is performed within the initial BWP, the value of X1 and the value of Y1 may be determined based on an SCS of the initial UL BWP. For instance, in a case where the transmission of the reference signal between the network device and the terminal is performed within the initial BWP, the value of X1 and the value of Y1 may be determined based on an SCS of the initial DL BWP.

In some embodiments, the value of X2 and the value of Y2 may be determined based on the SCS of the initial BWP.

For instance, in a case where the transmission of the reference signal between the network device and the terminal is performed within the initial BWP, the value of X2 and the value of Y2 may be determined based on the SCS of the initial UL BWP. For instance, in a case where the transmission of the reference signal between the network device and the terminal is performed within the initial BWP, the value of X2 and the value of Y2 may be determined based on the SCS of the initial DL BWP.

The present disclosure provides a determination mode for some parameters included in the terminal capability information and used for conflict determination, such that the transmission of the reference signal between the network device and the terminal may be performed based on the terminal capability information, and power consumption caused by terminal positioning can be reduced.

In the communication method according to the embodiment of the present disclosure, in a case where the transmission of the reference signal between the network device and the terminal is performed on a bandwidth other than the initial BWP, the terminal capability information further includes at least one of: a value of X3 and a value of Y3; or a value of X4 and a value of Y4.

In some embodiments, in a case where the transmission of the reference signal between the network device and the terminal is performed on a bandwidth other than the initial BWP, the conflict determination mode indication information in the terminal capability information received by the network device from the terminal may indicate that a conflict determination mode is at least one of the conflict criterion 5, the conflict criterion 6, or the conflict criterion 7.

In some embodiments, in a case of indicating that the conflict determination mode is the conflict criterion 6, the terminal capability information further includes the value of X3 and the value of Y3.

In some embodiments, in a case of indicating that the conflict determination mode is the conflict criterion 7, the terminal capability information further includes the value of X4 and the value of Y4.

The terminal capability information of the present disclosure may further include some parameter values for determination of some conflicts, such that the transmission of the reference signal between the network device and the terminal may be performed based on the terminal capability information, and power consumption caused by terminal positioning can be reduced.

In the communication method according to the embodiment of the present disclosure, the value of X3 and the value of Y3 are determined based on an SCS of the initial BWP, alternatively the value of X3 and the value of Y3 are determined based on an SCS of a BWP where the reference signal is located. The value of X4 and the value of Y4 are determined based on the SCS of the initial BWP, alternatively the value of X4 and the value of Y4 are determined based on the SCS of the BWP where the reference signal is located.

In some embodiments, the value of X3 and the value of Y3 may be determined based on the SCS of the initial BWP. Alternatively, the value of X3 and the value of Y3 may be determined based on the SCS of the BWP where the reference signal is located.

For instance, in a case where the transmission of the reference signal between the network device and the terminal is performed on a bandwidth other than the initial BWP, the value of X3 and the value of Y3 may be determined based on an SCS of the initial UL BWP. For instance, in a case where the transmission of the reference signal between the network device and the terminal is performed on a bandwidth other than the initial BWP, the value of X3 and the value of Y3 may be determined based on an SCS of the initial DL BWP.

In some embodiments, the value of X4 and the value of Y4 may be determined based on the SCS of the initial BWP. Alternatively, the value of X4 and the value of Y4 may be determined based on the SCS of the BWP where the reference signal is located.

For instance, in a case where the transmission of the reference signal between the network device and the terminal is performed on a bandwidth other than the initial BWP, the value of X4 and the value of Y4 may be determined based on the SCS of the initial UL BWP. For instance, in a case where the transmission of the reference signal between the network device and the terminal is performed on a bandwidth other than the initial BWP, the value of X4 and the value of Y4 may be determined based on the SCS of the initial DL BWP.

The present disclosure provides a determination mode for some parameters included in the terminal capability information and used for conflict determination, such that the transmission of the reference signal between the network device and the terminal may be performed based on the terminal capability information, and power consumption caused by terminal positioning can be reduced.

In the communication method according to the embodiment of the present disclosure, a configuration parameter for the reference signal processing window is the first configuration parameter or the second configuration parameter. The configuration parameter for the reference signal processing window includes at least one of: a time domain parameter; a frequency domain parameter; or terminal-specific information.

In some embodiments, the configuration parameter for the reference signal processing window may be the first configuration parameter or the second configuration parameter.

In some embodiments, the configuration parameter for the reference signal processing window may include the time domain parameter.

In some embodiments, the configuration parameter for the reference signal processing window may include the frequency domain parameter.

In some embodiments, the configuration parameter for the reference signal processing window may include the terminal-specific information.

For instance, the terminal-specific information may include a terminal identity, a terminal paging occasion, and other terminal-related information.

The present disclosure provides different configuration parameters for the reference signal processing window, such that the reference signal processing window may be determined and configured based on the configuration parameter for the reference signal processing window, the reference signal may be processed within the corresponding reference signal processing window, and further power consumption caused by terminal positioning can be reduced.

It may be understood that reference may be made to corresponding description in FIG. 2 to FIG. 7 for implementation processes of the solution described in FIG. 8 to FIG. 10, which will not be repeated in the present disclosure.

It is to be noted that those skilled in the art can understand that all the implementations/embodiments related to the embodiments of the present disclosure can be used together with the above embodiments or independently. Whether the implementations/embodiments are used independently or in combination with the above embodiments, they have a similar implementation principle. In implementation of the present disclosure, some embodiments are described as the implementation used together. Clearly, those skilled in the art can understand that such illustration does not limit the embodiments of the present disclosure.

Based on an identical concept, an embodiment of the present disclosure further provides a communication apparatus and a communication device.

It may be understood that the communication apparatus and the communication device according to the embodiment of the present disclosure include corresponding hardware structures and/or software modules for executing respective functions, so as to achieve the mentioned functions. In combination with units and algorithmic steps of each instance disclosed in the embodiment of the present disclosure, the embodiment of the present disclosure may be implemented in a form of hardware or a combination of hardware and computer software. Whether certain function is executed in a mode of hardware or of driving hardware by computer software depends on an application and design constraints of the technical solution. Those skilled in the art may achieve the described functions for each particular application in different ways, but such implementation is not considered to be beyond the scope of the technical solution of the embodiments of the present disclosure.

FIG. 11 is a schematic diagram of a communication apparatus according to an example. With reference to FIG. 11, the communication apparatus 200 is configured in a terminal. The communication apparatus 200 includes: a determination module 201 configured to determine, in a case where the terminal is in a non-connected state, a first configuration parameter configured to configure a reference signal processing window, where the determination module 201 is further configured to determine the reference signal processing window based on the first configuration parameter; and a processing module 202 configured to process a reference signal based on the reference signal processing window.

In the present disclosure, the first configuration parameter configured to configure the reference signal processing window is determined, such that the reference signal is processed within the corresponding reference signal processing window, and further power consumption caused by terminal positioning is reduced.

In some implementations, in a case where the non-connected state is an inactive state, the communication apparatus 200 further includes a reception module 203. The first configuration parameter is determined in any one of the following ways: the reception module 203 receiving a first radio resource control (RRC) release message transmitted by a network device, where the first RRC release message includes the first configuration parameter; or the determination module 201 determining, based on a second configuration parameter while the terminal is in a connected state, the first configuration parameter, where the second configuration parameter is a configuration parameter configured to configure the reference signal processing window while the terminal is in the connected state.

The present disclosure provides a way for the terminal in the inactive state to determine the reference signal processing window, such that the terminal may process the reference signal within the corresponding reference signal processing window, and further power consumption caused by terminal positioning is reduced.

In some implementations, in a case where the non-connected state is an idle state, the communication apparatus 200 further includes the reception module 203. The first configuration parameter is determined in any one of the following ways: the reception module 203 receiving, in a case where the network device is a core network device, a configuration parameter transmitted by the core network device; the reception module 203 receiving a configuration parameter carried in broadcast information transmitted by the network device; the reception module 203 receiving a configuration parameter in a second RRC release message transmitted by the network device, where the second RRC release message includes the first configuration parameter; or the reception module 203 receiving a configuration parameter transmitted by the network device in an RA procedure.

The present disclosure provides a way for the terminal in the idle state to determine the reference signal processing window, such that the terminal may process the reference signal within the corresponding reference signal processing window, and further power consumption caused by terminal positioning is reduced.

In some implementations, the processing module 202 is further configured to process, in a case where a time domain for the reference signal conflicts with a time domain for other information, the reference signal. The other information includes at least one of any channel or any signal except the reference signal.

In the present disclosure, the reference signal is processed within the reference signal processing window based on a conflict between the time domain for the reference signal and the time domain for the other information. In this way, power consumption caused by terminal positioning is reduced.

In some implementations, the other information includes at least one of: at least one of a channel or a signal of a serving cell; or at least one of a channel or a signal of a neighboring cell.

The present disclosure may be applied to a scenario where a time domain for at least one of the channel or the signal of the serving cell conflicts with the time domain for the reference signal, and may further be applied to a scenario where a time domain for at least one of the channel or the signal of the neighboring cell conflicts with the time domain for the reference signal. Thus, in different scenarios, the terminal may process the reference signal within the corresponding reference signal processing window, and further power consumption caused by terminal positioning is reduced.

In some implementations, the at least one of the channel or the signal of the serving cell includes at least one of: an SSB of the serving cell; an SIB 1 of the serving cell; a CORESET 0 of the serving cell; a MSG 2 or an MSG B of the serving cell; a paging message of the serving cell; or uplink or downlink SDT of the serving cell.

The present disclosure provides various different channels and/or signals of the serving cells, such that in a scenario where the time domain for at least one of the channel or the signal of the serving cell conflicts with the time domain for the reference signal, the terminal may process the reference signal within the corresponding reference signal processing window, and further power consumption caused by terminal positioning is reduced.

In some implementations, the at least one of the channel or the signal of the neighboring cell includes at least one of: an SSB of the neighboring cell; an SIB 1 of the neighboring cell; a CSI-RS of the neighboring cell; or a CORESET 0 of the neighboring cell.

The present disclosure provides various different channels and/or signals of the neighboring cells, such that in a scenario where the time domain for at least one of the channel or the signal of the neighboring cell conflicts with the time domain for the reference signal, the terminal may process the reference signal within the corresponding reference signal processing window, and further power consumption caused by terminal positioning is reduced.

In some implementations, in a case where the terminal transmits the reference signal within an initial BWP, the determination module 201 is further configured to determine that the time domain for the reference signal conflicts with the time domain for the other information in at least one of the following ways: determining that the time domain for the reference signal conflicts with the time domain for the other information, in a case where the reference signal overlaps with the other information in at least one symbol; determining that the time domain for the reference signal conflicts with a time domain for second other information, in a case where first other information is at N symbols before a starting location of the reference signal processing window and the second other information is within the reference signal processing window, where N is less than a first threshold, the other information includes the first other information and the second other information, and the first other information is configured to indicate a location of the time domain for the second other information; determining that the time domain for the reference signal conflicts with the time domain for the other information, in a case where the reference signal overlaps with a first time window in at least one symbol, where a starting location of the first time window is at X1 symbols or slots before the other information, and an ending location of the first time window is at Y1 symbols or slots after the other information; or determining that the time domain for the reference signal conflicts with the time domain for the other information, in a case where a second time window overlaps with the other information in at least one symbol, where a starting location of the second time window is at X2 symbols or slots before the reference signal, an ending location of the second time window is at Y2 symbols or slots after the reference signal, X1 and X2 may be identical or not, Y1 and Y2 may be identical or not, and the reference signal processing window includes at least one symbol of at least one of the first time window or the second time window.

The present disclosure provides various conflict determination modes, such that the terminal processes the reference signal within the reference signal processing window based on the conflict between the time domain for the reference signal and the time domain for the other information. In this way, power consumption caused by terminal positioning is reduced.

In some implementations, in a case where the terminal transmits the reference signal on a bandwidth other than the initial BWP, the determination module 201 is further configured to determine that the time domain for the reference signal conflicts with the time domain for the other information in at least one of the following ways: determining that the time domain for the reference signal conflicts with a time domain for fourth other information, in a case where third other information is at M symbols before a starting location of the reference signal processing window and the fourth other information is within the reference signal processing window, where M is less than a second threshold, the other information includes the third other information and the fourth other information, and the third other information is configured to indicate a location of the time domain for the fourth other information; determining that the time domain for the reference signal conflicts with the time domain for the other information, in a case where the reference signal overlaps with a third time window in at least one symbol, where a starting location of the third time window is at X3 symbols or slots before the other information, and an ending location of the third time window is at Y3 symbols or slots after the other information; or determining that the time domain for the reference signal conflicts with the time domain for the other information, in a case where a fourth time window overlaps with the other information in at least one symbol, where a starting location of the fourth time window is at X4 symbols or slots before the reference signal, an ending location of the fourth time window is at Y4 symbols or slots after the reference signal, X3 and X4 may be identical or not, Y3 and Y4 may be identical or not, and the reference signal processing window includes at least one symbol of at least one of the third time window or the fourth time window.

The present disclosure provides various conflict determination modes, such that the terminal processes the reference signal within the reference signal processing window based on the conflict between the time domain for the reference signal and the time domain for the other information. In this way, power consumption caused by terminal positioning is reduced.

In some implementations, in a case where the time domain for the reference signal conflicts with the time domain for the second other information, the processing module 202 is further configured to transmit the reference signal.

In the present disclosure, in a scenario where the terminal transmits the reference signal within the initial BWP, in a case where the time domain for the reference signal conflicts with the time domain for the second other information, the terminal transmits the reference signal. Power consumption caused by terminal positioning can be reduced.

In some implementations, in a case where the time domain for the reference signal conflicts with the time domain for the fourth other information, the processing module 202 is further configured to transmit the reference signal.

In the present disclosure, in a scenario where the terminal transmits the reference signal on a bandwidth other than the initial BWP, in a case where the time domain for the reference signal conflicts with the time domain for the fourth other information, the terminal transmits the reference signal. Power consumption caused by terminal positioning can be reduced.

In some implementations, the processing module 202 is further configured to transmit information having highest priority among the reference signal and the other information based on a priority rule.

According to the present disclosure, the information having the highest priority may be transmitted within the corresponding reference signal processing window based on the priority rule, and power consumption caused by terminal positioning can be reduced.

In some implementations, the priority rule includes: at least one of priority of the reference signal being higher than priority of at least one of a channel or a signal of the serving cell, or priority of the reference signal being higher than priority of at least one of a channel or a signal of the neighboring cell; or at least one of priority of the reference signal being lower than priority of at least one of a channel or a signal of the serving cell, or priority of the reference signal being lower than priority of at least one of a channel or a signal of the neighboring cell.

The present disclosure provides various priority rules, such that the terminal may transmit the information having the highest priority within the corresponding reference signal processing window, and power consumption caused by terminal positioning can be reduced.

In some implementations, in a case where the priority of the reference signal is higher than the priority of at least one of the channel or the signal of the serving cell, the processing module 202 is further configured to transmit the reference signal; or transmit the reference signal and at least one of a channel or a signal of the serving cell on other CCs except a designated CC. The designated CC is a CC where the reference signal is located.

In a case where the priority rule is that the priority of the reference signal is higher than the priority of at least one of the channel or the signal of the serving cell, it may only transmit the reference signal, or transmit the reference signal and at least one of the channel or the signal of the serving cell on the other CCs except the designated CC, such that power consumption caused by terminal positioning can be reduced.

In some implementations, in a case where the priority of the reference signal is higher than the priority of at least one of the channel or the signal of the neighboring cell, the processing module 202 is further configured to transmit the reference signal; or transmit the reference signal and at least one of other channel or other signal of the neighboring cell on other CCs except a designated CC. The designated CC is a CC where the reference signal is located.

In a case where the priority rule is that the priority of the reference signal is higher than the priority of at least one of the channel or the signal of the neighboring cell, it may only transmit the reference signal, or transmit the reference signal and at least one of the channel or the signal of the neighboring cell on the other CCs except the designated CC, such that power consumption caused by terminal positioning can be reduced.

In some implementations, the communication apparatus 200 further includes a transmission module 204 configured to transmit terminal capability information to the network device. The terminal capability information includes conflict determination mode indication information. The conflict determination mode indication information is configured to indicate a determination mode for determining that the time domain for the reference signal conflicts with the time domain for the other information.

The terminal of the present disclosure may further transmit the terminal capability information to the network device, such that the transmission of the reference signal between the network device and the terminal may be performed based on the terminal capability information, and power consumption caused by terminal positioning can be reduced.

In some implementations, in a case where the terminal transmits the reference signal within the initial BWP, the terminal capability information further includes at least one of: a value of X1 and a value of Y1; or a value of X2 and a value of Y2.

The terminal capability information of the present disclosure may further include some parameter values for determination of some conflicts, such that the transmission of the reference signal between the network device and the terminal may be performed based on the terminal capability information, and power consumption caused by terminal positioning can be reduced.

In some implementations, the value of X1 and the value of Y1 are determined based on an SCS of the initial BWP; and the value of X2 and the value of Y2 are determined based on the SCS of the initial BWP.

The present disclosure provides a determination mode for some parameters included in the terminal capability information and used for conflict determination, such that the transmission of the reference signal between the network device and the terminal may be performed based on the terminal capability information, and power consumption caused by terminal positioning can be reduced.

In some implementations, in a case where the terminal transmits the reference signal on a bandwidth other than the initial BWP, the terminal capability information further includes at least one of: a value of X3 and a value of Y3; or a value of X4 and a value of Y4.

The terminal capability information of the present disclosure may further include some parameter values for determination of some conflicts, such that the transmission of the reference signal between the network device and the terminal may be performed based on the terminal capability information, and power consumption caused by terminal positioning can be reduced.

In some implementations, the value of X3 and the value of Y3 are determined based on an SCS of the initial BWP, or the value of X3 and the value of Y3 are determined based on an SCS of a BWP where the reference signal is located. The value of X4 and the value of Y4 are determined based on the SCS of the initial BWP, or the value of X4 and the value of Y4 are determined based on the SCS of the BWP where the reference signal is located.

The present disclosure provides a determination mode for some parameters included in the terminal capability information and used for conflict determination, such that the transmission of the reference signal between the network device and the terminal may be performed based on the terminal capability information, and power consumption caused by terminal positioning can be reduced.

In some implementations, a configuration parameter for the reference signal processing window is the first configuration parameter or the second configuration parameter. The configuration parameter for the reference signal processing window includes at least one of: a time domain parameter; a frequency domain parameter; or terminal-specific information.

The present disclosure provides different configuration parameters for the reference signal processing window, such that the reference signal processing window may be determined and configured based on the configuration parameter for the reference signal processing window, the reference signal may be processed within the corresponding reference signal processing window, and further power consumption caused by terminal positioning can be reduced.

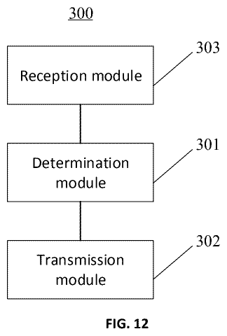

FIG. 12 is a schematic diagram of another communication apparatus according to an example. With reference to FIG. 12, the communication apparatus 300 is configured in a network device. The communication apparatus 300 includes: a determination module 301 configured to determine, in a case where a terminal is in a non-connected state, a first configuration parameter configured to configure a reference signal processing window. The first configuration parameter is configured to instruct the terminal to determine the reference signal processing window and to process a reference signal based on the reference signal processing window.

In the present disclosure, the first configuration parameter configured to configure the reference signal processing window is determined, such that the terminal processes the reference signal within the corresponding reference signal processing window, and further power consumption caused by terminal positioning is reduced.

In some implementations, the communication apparatus 300 further includes a transmission module 302. The transmission module 302 is configured to perform at least one of:
transmitting, in a case where the non-connected state is an inactive state, a first radio resource control (RRC) release message to the terminal, where the first RRC release message includes the first configuration parameter; or transmitting, in a case where the terminal is in a connected state, second configuration parameter to the terminal, where the second configuration parameter is a configuration parameter configured to configure the reference signal processing window while the terminal is in the connected state.

The present disclosure provides that the network device indicates the reference signal processing window to the terminal in various modes, such that the terminal in various states may process the reference signal within the corresponding reference signal processing window, and further power consumption caused by terminal positioning is reduced.

In some implementations, in a case where the non-connected state is an idle state, the communication apparatus 300 further includes the transmission module 302. The transmission module 302 is configured to perform at least one of: transmitting to the terminal a configuration parameter configured to indicate the first configuration parameter, in a case where the network device is a core network device; transmitting to the terminal broadcast information carrying a configuration parameter configured to indicate the first configuration parameter; transmitting a second RRC release message to the terminal, where the second RRC release message includes the first configuration parameter; or transmitting to the terminal, in an RA procedure, a configuration parameter configured to indicate the first configuration parameter.

The present disclosure provides various ways for the network device to configure the reference signal processing window for the terminal in the idle state, such that the terminal may process the reference signal within the corresponding reference signal processing window, and further power consumption caused by terminal positioning is reduced.

In some implementations, the first configuration parameter is further configured to instruct, in a case where a time domain for the reference signal conflicts with a time domain for other information, the terminal to process the reference signal. The other information includes at least one of any channel or any signal except the reference signal.

In the present disclosure, the reference signal is processed within the reference signal processing window based on a conflict between the time domain for the reference signal and the time domain for the other information. In this way, power consumption caused by terminal positioning is reduced.

In some implementations, the other information includes at least one of: at least one of a channel or a signal of a serving cell; or at least one of a channel or a signal of a neighboring cell.

The present disclosure may be applied to a scenario where a time domain for at least one of the channel or the signal of the serving cell conflicts with the time domain for the reference signal, and may further be applied to a scenario where a time domain for at least one of the channel or the signal of the neighboring cell conflicts with the time domain for the reference signal. Thus, in different scenarios, the terminal may process the reference signal within the corresponding reference signal processing window, and further power consumption caused by terminal positioning is reduced.

In some implementations, the at least one of the channel or the signal of the serving cell includes at least one of: an SSB of the serving cell; an SIB 1 of the serving cell; a CORESET 0 of the serving cell; a MSG 2 or an MSG B of the serving cell; a paging message of the serving cell; or uplink or downlink SDT of the serving cell.

The present disclosure provides various different channels and/or signals of the serving cells, such that in a scenario where the time domain for at least one of the channel or the signal of the serving cell conflicts with the time domain for the reference signal, the terminal may process the reference signal within the corresponding reference signal processing window, and further power consumption caused by terminal positioning is reduced.

In some implementations, the at least one of the channel or the signal of the neighboring cell includes at least one of: an SSB of the neighboring cell; an SIB 1 of the neighboring cell; a CSI-RS of the neighboring cell; or a CORESET 0 of the neighboring cell.

The present disclosure provides various different channels and/or signals of the neighboring cells, such that in a scenario where the time domain for at least one of the channel or the signal of the neighboring cell conflicts with the time domain for the reference signal, the terminal may process the reference signal within the corresponding reference signal processing window, and further power consumption caused by terminal positioning is reduced.

In some implementations, in a case where the transmission of the reference signal between the network device and the terminal is performed within an initial BWP, it is determined that the time domain for the reference signal conflicts with the time domain for the other information in at least one of the following ways: determining that the time domain for the reference signal conflicts with the time domain for the other information, in a case where the reference signal overlaps with the other information in at least one symbol; determining that the time domain for the reference signal conflicts with a time domain for second other information, in a case where first other information is at N symbols before a starting location of the reference signal processing window and the second other information is within the reference signal processing window, where N is less than a first threshold, the other information includes the first other information and the second other information, and the first other information is configured to indicate a location of the time domain for the second other information; determining that the time domain for the reference signal conflicts with the time domain for the other information, in a case where the reference signal overlaps with a first time window in at least one symbol, where a starting location of the first time window is at X1 symbols or slots before the other information, and an ending location of the first time window is at Y1 symbols or slots after the other information; or determining that the time domain for the reference signal conflicts with the time domain for the other information, in a case where a second time window overlaps with the other information in at least one symbol, where a starting location of the second time window is at X2 symbols or slots before the reference signal, an ending location of the second time window is at Y2 symbols or slots after the reference signal, X1 and X2 may be identical or not, Y1 and Y2 may be identical or not, and the reference signal processing window includes at least one symbol of at least one of the first time window or the second time window.

The present disclosure provides various conflict determination modes, such that the terminal processes the reference signal within the reference signal processing window based on the conflict between the time domain for the reference signal and the time domain for the other information. In this way, power consumption caused by terminal positioning is reduced.

In some implementations, in a case where the transmission of the reference signal between the network device and the terminal is performed on a bandwidth other than the initial BWP, it is determined that the time domain for the reference signal conflicts with the time domain for the other information in at least one of the following ways: determining that the time domain for the reference signal conflicts with a time domain for fourth other information, in a case where third other information is at M symbols before a starting location of the reference signal processing window and the fourth other information is within the reference signal processing window, where M is less than a second threshold, the other information includes the third other information and the fourth other information, and the third other information is configured to indicate a location of the time domain for the fourth other information; determining that the time domain for the reference signal conflicts with the time domain for the other information, in a case where the reference signal overlaps with a third time window in at least one symbol, where a starting location of the third time window is at X3 symbols or slots before the other information, and an ending location of the third time window is at Y3 symbols or slots after the other information; or determining that the time domain for the reference signal conflicts with the time domain for the other information, in a case where a fourth time window overlaps with the other information in at least one symbol, where a starting location of the fourth time window is at X4 symbols or slots before the reference signal, an ending location of the fourth time window is at Y4 symbols or slots after the reference signal, X3 and X4 may be identical or not, Y3 and Y4 may be identical or not, and the reference signal processing window includes at least one symbol of at least one of the third time window or the fourth time window.

The present disclosure provides various conflict determination modes, such that the terminal processes the reference signal within the reference signal processing window based on the conflict between the time domain for the reference signal and the time domain for the other information. In this way, power consumption caused by terminal positioning is reduced.

In some implementations, in a case where the time domain for the reference signal conflicts with the time domain for the second other information, the first configuration parameter is further configured to instruct the terminal to transmit the reference signal.

According to the present disclosure, in a scenario where the transmission of the reference signal between the network device and the terminal is performed within the initial BWP, in a case where the time domain for the reference signal conflicts with the time domain for the second other information, the first configuration parameter instructs the terminal to transmit the reference signal. Power consumption caused by terminal positioning can be reduced.

In some implementations, in a case where the time domain for the reference signal conflicts with the time domain for the fourth other information, the first configuration parameter is further configured to instruct the terminal to transmit the reference signal.

In the present disclosure, in a scenario where the transmission of the reference signal between the network device and the terminal is performed on a bandwidth other than the initial BWP, in a case where the time domain for the reference signal conflicts with the time domain for the fourth other information, the first configuration parameter instructs the terminal to transmit the reference signal. Power consumption caused by terminal positioning can be reduced.

In some implementations, the first configuration parameter is further configured to instruct the terminal to transmit information having highest priority among the reference signal and the other information based on a priority rule.

According to the present disclosure, the information having the highest priority may be transmitted within the corresponding reference signal processing window based on the priority rule, and power consumption caused by terminal positioning can be reduced.

In some implementations, the priority rule includes: at least one of priority of the reference signal being higher than priority of at least one of a channel or a signal of the serving cell, or priority of the reference signal being higher than priority of at least one of a channel or a signal of the neighboring cell; or at least one of priority of the reference signal being lower than priority of at least one of a channel or a signal of the serving cell, or priority of the reference signal being lower than priority of at least one of a channel or a signal of the neighboring cell.

The present disclosure provides various priority rules, such that the terminal may transmit the information having the highest priority within the corresponding reference signal processing window, and power consumption caused by terminal positioning can be reduced.

In some implementations, in a case where the priority of the reference signal is higher than the priority of at least one of the channel or the signal of the serving cell, the first configuration parameter is further configured to instruct the terminal to transmit the reference signal; or to instruct the terminal to transmit the reference signal and at least one of other channel or other signal of the serving cell on other CCs except a designated CC. The designated CC is a CC where the reference signal is located.

According to the present disclosure, in a case where the priority rule is that the priority of the reference signal is higher than the priority of at least one of the channel or the signal of the serving cell, the first configuration parameter may indicate only transmission of the reference signal, or transmission of the reference signal and at least one of the channel or the signal of the serving cell on the other CCs except the designated CC, such that power consumption caused by terminal positioning can be reduced.

In some implementations, in a case where the priority of the reference signal is higher than the priority of at least one of the channel or the signal of the neighboring cell, the first configuration parameter is further configured to instruct the terminal to transmit the reference signal; or to instruct the terminal to transmit the reference signal and at least one of other channel or other signal of the neighboring cell on other CCs except a designated CC. The designated CC is a CC where the reference signal is located.

According to the present disclosure, in a case where the priority rule is that the priority of the reference signal is higher than the priority of at least one of the channel or the signal of the neighboring cell, the first configuration parameter may indicate only transmission of the reference signal, or transmission of the reference signal and at least one of the channel or the signal of the neighboring cell on the other CCs except the designated CC, such that power consumption caused by terminal positioning can be reduced.

In some implementations, the communication apparatus 300 further includes: a reception module 303 configured to receive terminal capability information transmitted by the terminal. The terminal capability information includes conflict determination mode indication information. The conflict determination mode indication information is configured to indicate a determination mode used by the terminal to determine that the time domain for the reference signal conflicts with the time domain for the other information.

The network device of the present disclosure may further receive the terminal capability information transmitted by the terminal, such that the transmission of the reference signal between the network device and the terminal may be performed based on the terminal capability information, and power consumption caused by terminal positioning can be reduced.

In some implementations, in a case where the transmission of the reference signal between the network device and the terminal is performed within the initial BWP, the terminal capability information further includes at least one of: a value of X1 and a value of Y1; or a value of X2 and a value of Y2.

The terminal capability information of the present disclosure may further include some parameter values for determination of some conflicts, such that the transmission of the reference signal between the network device and the terminal may be performed based on the terminal capability information, and power consumption caused by terminal positioning can be reduced.

In some implementations, the value of X1 and the value of Y1 are determined based on an SCS of the initial BWP; and the value of X2 and the value of Y2 are determined based on the SCS of the initial BWP.

The present disclosure provides a determination mode for some parameters included in the terminal capability information and used for conflict determination, such that the transmission of the reference signal between the network device and the terminal may be performed based on the terminal capability information, and power consumption caused by terminal positioning can be reduced.

In some implementations, in a case where the transmission of the reference signal between the network device and the terminal is performed on a bandwidth other than the initial BWP, the terminal capability information further includes at least one of: a value of X3 and a value of Y3; or a value of X4 and a value of Y4.

The terminal capability information of the present disclosure may further include some parameter values for determination of some conflicts, such that the transmission of the reference signal between the network device and the terminal may be performed based on the terminal capability information, and power consumption caused by terminal positioning can be reduced.

In some implementations, the value of X3 and the value of Y3 are determined based on the SCS of the initial BWP, or the value of X3 and the value of Y3 are determined based on an SCS of a BWP where the reference signal is located. The value of X4 and the value of Y4 are determined based on the SCS of the initial BWP, or the value of X4 and the value of Y4 are determined based on the SCS of the BWP where the reference signal is located.

The present disclosure provides a determination mode for some parameters included in the terminal capability information and used for conflict determination, such that the transmission of the reference signal between the network device and the terminal may be performed based on the terminal capability information, and power consumption caused by terminal positioning can be reduced.

In some implementations, a configuration parameter for the reference signal processing window is the first configuration parameter or the second configuration parameter. The configuration parameter for the reference signal processing window includes at least one of: a time domain parameter; a frequency domain parameter; or terminal-specific information.

The present disclosure provides different configuration parameters for the reference signal processing window, such that the reference signal processing window may be determined and configured based on the configuration parameter for the reference signal processing window, the reference signal may be processed within the corresponding reference signal processing window, and further power consumption caused by terminal positioning can be reduced.

For the apparatus in the embodiments, a way for each module to execute an operation is described in detail in the embodiments relating to the method, and will not be described in detail here.

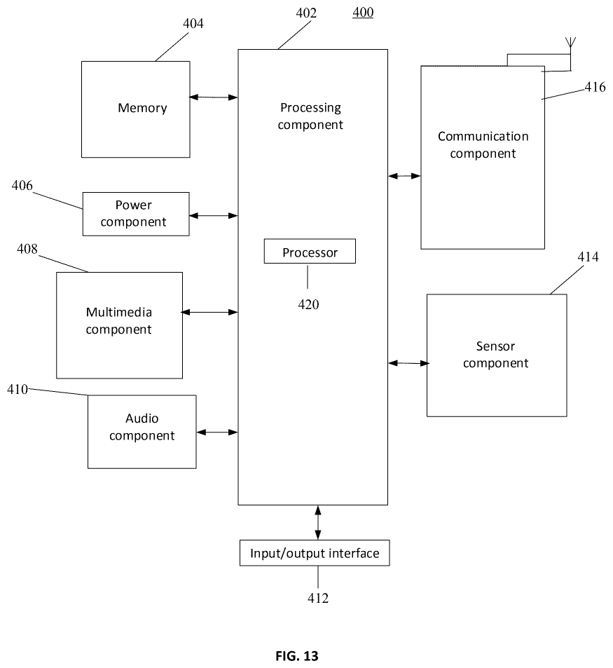

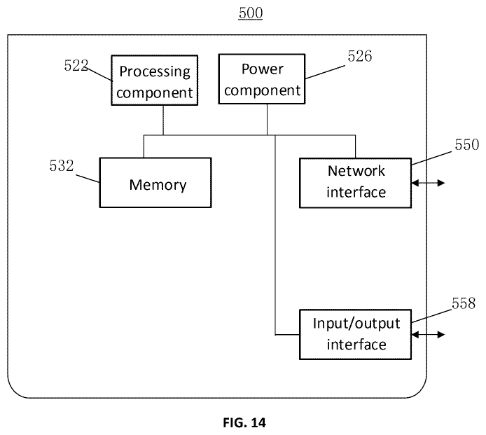

FIG. 13 is a schematic diagram of a communication device according to an example. For instance, the communication device 400 may be a mobile phone, a computer, a digital broadcast terminal, a messaging device, a game console, a tablet device, a medical device, a fitness device, a personal digital assistant, or any other terminals.

With reference to FIG. 13, the communication device 400 may include one or more of the following components: a processing component 402, a memory 404, a power component 406, a multimedia component 408, an audio component 410, an input/output (I/O) interface 412, a sensor component 414, and a communication component 416.

The processing component 402 generally controls overall operations of the communication device 400, such as operations associated with display, telephone call, data communication, camera operations and recording operations. The processing component 402 may include one or more processors 420 configured to execute instructions, so as to complete all or some steps of the method. In addition, the processing component 402 may include one or more modules to facilitate interaction between the processing component 402 and other components. For instance, the processing component 402 may include a multimedia module to facilitate interaction between the multimedia component 408 and the processing component 402.

The memory 404 is configured to store various types of data to support the operations on the communication device 400. Instances of the data include instructions for any application or method operating on the communication device 400, contact data, phone book data, messages, pictures, videos, etc. The memory 404 may be implemented by any type of volatile or nonvolatile memory device or their combinations, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk, or an optical disk.

The power component 406 supplies power to various components of the communication device 400. The power component 406 may include a power management system, one or more power supplies, and other components associated with generating, managing and distributing power for the communication device 400.

The multimedia component 408 includes a screen that provides an output interface between the communication device 400 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense touch, slide and gestures on the touch panel. The touch sensor may sense a boundary of a touch or slide operation, and detect duration and pressure related to the touch or slide operation. In some embodiments, the multimedia component 408 includes at least one of a front-facing camera or a rear-facing camera. When the communication device 400 is in an operation mode, such as a photographing mode or a video mode, at least one of the front-facing camera or the rear-facing camera is capable of receiving external multimedia data. Each of the front-facing camera and the rear-facing camera may be a fixed optical lens system or have a focal length and an optical zoom capability.

The audio component 410 is configured to output and/or input an audio signal. For instance, the audio component 410 includes a microphone (MIC). The microphone is configured to receive an external audio signal when the communication device 400 is in the operation mode, for instance, a calling mode, a recording mode, and a speech identification mode. The received audio signal may be further stored in the memory 404 or transmitted via the communication component 416. In some embodiments, the audio component 410 further includes a speaker configured to output an audio signal.

The I/O interface 412 provides an interface between the processing component 402 and a peripheral interface module. The peripheral interface module may be a keyboard, a click wheel, a button, etc. The buttons may include, but are not limited to, a home button, a volume button, a start button, and a lock button.

The sensor component 414 includes one or more sensors configured to provide various aspects of state assessment for the communication device 400. For instance, the sensor component 414 may detect an on/off state of the communication device 400 and relative positioning of the components, such as a display and a keypad of the communication device 400, and the sensor component 414 may further detect location change of the communication device 400 or a component of the communication device 400, presence or absence of contact between the user and the communication device 400, an orientation or acceleration/deceleration of the communication device 400, and temperature change of the communication device 400. The sensor component 414 may include a proximity sensor configured to detect presence of a nearby object without any physical contact. The sensor component 414 may further include an optical sensor, such as a complementary metal-oxide-semiconductor (CMOS) or charge-coupled device (CCD) image sensor, which is used in an imaging application. In some embodiments, the sensor component 414 may further include an acceleration sensor, a gyroscope sensor, a magnetic sensor, a pressure sensor, or a temperature sensor.

The communication component 416 is configured to facilitate wired or wireless communication between the communication device 400 and other devices. The communication device 400 may access a radio network based on a communication standard, such as wireless fidelity (WiFi), 2G or 3G, or their combination. In one example, the communication component 416 receives a broadcast signal or broadcast related information from an external broadcast management system via a broadcast channel. In one example, the communication component 416 further includes a near field communication (NFC) module to facilitate short-range communication. For instance, the NFC module may be implemented on the basis of a radio frequency identification (RFID) technology, an infrared data association (IrDA) technology, an ultra-wideband (UWB) technology, a Bluetooth (BT) technology or other technologies.

In an example, the communication device 400 may be implemented by one or more of an application specific integrated circuit (ASIC), a digital signal processor (DSP), a digital signal processing device (DSPD), a programmable logic device (PLD), a field programmable gate array (FPGA), a controller, a microcontroller, a microprocessor, or other electronic elements, thus performing the method of the present disclosure.

An example further provides a non-transitory computer-readable storage medium including instructions, such as the memory 404 including instructions. The instructions may be executed by the processor 420 of the communication device 400 so as to complete the method of the present disclosure. For instance, the non-transitory computer-readable storage medium may be a ROM, a random access memory (RAM), a compact disc-read only memory (CD-ROM), a magnetic tape, a floppy disk, an optical data storage device, etc.

FIG. 14 is a schematic diagram of another communication device according to an example. For instance, the communication device 500 may be provided as a base station or a server. With reference to FIG. 14, the communication device 500 includes: a processing component 522, where the processing component 522 further includes one or more processors; and a memory resource represented by a memory 532, configured to store instructions, such as applications, executable by the processing component 522. The application stored in the memory 532 may include one or more modules that each corresponds to a group of instructions. In addition, the processing component 522 is configured to execute the instructions, so as to perform the method of the present disclosure.

The communication device 500 may further include: a power component 526, configured to perform power management of the communication device 500; a wired or wireless network interface 550, configured to connect the communication device 500 to a network; and an input/output (I/O) interface 558. The communication device 500 may operate based on an operating system stored in the memory 532, such as Windows Server™, Mac OS^{X}™, X™ Unix ™ Linux™, FreeBSD™, etc.

For user equipment (UE) in an RRC_INACTIVE state or an RRC_IDLE state, the present disclosure introduces a PRS and SRS processing window, and configures a priority processing rule between the PRS/SRS and other signals within the processing window, so as to reduce power consumption caused by terminal positioning.

It may be further understood that “a plurality of” in the present disclosure refers to two or above, and that other quantifiers are understood in a similar way. When describing an association relation of associated objects, “and/or” means that there may be three relations. For instance, “A and/or B” may mean that A exists alone, both A and B exist, or B exists alone. The character “/” generally indicates an “or” relation between two associated context objects. The singular forms such as “a,” “an,” and “the” are also intended to include the plural forms, unless otherwise clearly stated in the context.

It may be further understood that terms “first,” “second”, etc. are used to describe various information, but such information is not limited to these terms. The terms are merely used to distinguish the same type of information from each other, and do not indicate a particular order or importance. In fact, expressions “first” and “second” may be used interchangeably. For instance, without departing from the scope of the present disclosure, first information can also be called second information, and similarly, second information can also be called first information.

It may be further understood that meanings of words such as “in a case where” and “if” involved in the present disclosure depend on the context and actual scenarios. For instance, the words “in a case where” used in the disclosure may be interpreted as “when,” “while,” “if,” or “in response to”.

It may be further understood that although operations are described in a specific order in the drawings in the embodiments of the present disclosure, it is not understood that the operations are required to be executed in the specific order or serial order shown or all the operations shown are required to be executed to obtain desired results. Under specific circumstances, multitasking and parallel processing may be advantageous.

Those skilled in the art could easily conceive of other implementation solutions of the present disclosure upon consideration of the description and the invention disclosed in the present disclosure. The present disclosure is intended to cover any variations, uses or adaptive changes of the present disclosure, which follow the general principles of the present disclosure and include common general knowledge or conventional technical means in the art not disclosed in the present disclosure.

It is to be understood that the present disclosure is not limited to a precise structure described in the present disclosure and illustrated in the accompanying drawings, and can be subjected to various modifications and changes without departing from the scope. The scope of the present disclosure is limited merely by the scope of the appended claims.

1. A communication method, performed by a terminal, the communication method comprising:
determining, in a case where the terminal is in a non-connected state, a first configuration parameter;
determining a reference signal processing window based on the first configuration parameter; and
processing a reference signal based on the reference signal processing window.

2. The communication method according to claim 1, wherein in a case where the non-connected state is an inactive state, the first configuration parameter is determined in any one of the following ways:
receiving a first radio resource control (RRC) release message transmitted by a network device, wherein the first RRC release message comprises the first configuration parameter; or
determining, based on a second configuration parameter while the terminal is in a connected state, the first configuration parameter, wherein the second configuration parameter is a configuration parameter configured to configure the reference signal processing window while the terminal is in the connected state.

3. The communication method according to claim 1, wherein in a case where the non-connected state is an idle state, the first configuration parameter is determined in any one of the following ways:
receiving, in a case where a network device is a core network device, a configuration parameter configured to indicate the first configuration parameter and transmitted by the core network device;
receiving a configuration parameter configured to indicate the first configuration parameter and carried in broadcast information transmitted by the network device;
receiving the first configuration parameter in a second radio resource control (RRC) release message transmitted by the network device; or
receiving, in a random access (RA) procedure, a configuration parameter configured to indicate the first configuration parameter and transmitted by the network device.

4. The communication method according to claim 1, wherein processing the reference signal comprises:
processing, in a case where a time domain for the reference signal conflicts with a time domain for other information, the reference signal, wherein the other information comprises at least one of any channel or any signal except the reference signal.

5. The communication method according to claim 4, wherein the other information comprises at least one of the following:
at least one of a channel or a signal of a serving cell; or
at least one of a channel or a signal of a neighboring cell.

6-7. (canceled)

8. The communication method according to claim 4, wherein in a case where the terminal transmits the reference signal within an initial bandwidth part (BWP), it is determined that the time domain for the reference signal conflicts with the time domain for the other information in at least one of the following ways:
determining, in a case where the reference signal overlaps with the other information in at least one symbol, that the time domain for the reference signal conflicts with the time domain for the other information;
determining, in a case where first other information is at N symbols before a starting location of the reference signal processing window and second other information is within the reference signal processing window, that the time domain for the reference signal conflicts with a time domain for the second other information, wherein N is less than a first threshold, the other information comprises the first other information and the second other information, and the first other information is configured to indicate a location of the time domain for the second other information;
determining, in a case where the reference signal overlaps with a first time window in at least one symbol, that the time domain for the reference signal conflicts with the time domain for the other information, wherein a starting location of the first time window is at X1 symbols or slots before the other information, and an ending location of the first time window is at Y1 symbols or slots after the other information; or
determining, in a case where a second time window overlaps with the other information in at least one symbol, that the time domain for the reference signal conflicts with the time domain for the other information, wherein a starting location of the second time window is at X2 symbols or slots before the reference signal, and an ending location of the second time window is at Y2 symbols or slots after the reference signal;
wherein X1 and X2 are identical or not, Y1 and Y2 are identical or not, and the reference signal processing window comprises at least one symbol of at least one of the first time window or the second time window.

9. The communication method according to claim 4, wherein in a case where the terminal transmits the reference signal on a bandwidth other than an initial bandwidth part (BWP), it is determined that the time domain for the reference signal conflicts with the time domain for the other information in at least one of the following ways:
determining, in a case where third other information is at M symbols before a starting location of the reference signal processing window and fourth other information is within the reference signal processing window, that the time domain for the reference signal conflicts with a time domain for the fourth other information, wherein M is less than a second threshold, the other information comprises the third other information and the fourth other information, and the third other information is configured to indicate a location of the time domain for the fourth other information;
determining, in a case where the reference signal overlaps with a third time window in at least one symbol, that the time domain for the reference signal conflicts with the time domain for the other information, wherein a starting location of the third time window is at X3 symbols or slots before the other information, and an ending location of the third time window is at Y3 symbols or slots after the other information; or determining, in a case where a fourth time window overlaps with the other information in at least one symbol, that the time domain for the reference signal conflicts with the time domain for the other information, wherein a starting location of the fourth time window is at X4 symbols or slots before the reference signal, and an ending location of the fourth time window is at Y4 symbols or slots after the reference signal;
wherein X3 and X4 are identical or not, Y3 and Y4 are identical or not, and the reference signal processing window comprises at least one symbol of at least one of the third time window or the fourth time window.

10-11. (canceled)

12. The communication method according to claim 4, wherein processing the reference signal comprises:
transmitting information having highest priority among the reference signal and the other information based on a priority rule;
wherein the priority rule comprises:
at least one of priority of the reference signal being higher than priority of at least one of a channel or a signal of a serving cell, or priority of the reference signal being higher than priority of at least one of a channel or a signal of a neighboring cell; or
at least one of priority of the reference signal being lower than priority of at least one of a channel or a signal of a serving cell, or priority of the reference signal being lower than priority of at least one of a channel or a signal of a neighboring cell.

13. (canceled)

14. The communication method according to claim 12, wherein in a case
transmitting the information having the highest priority among the reference signal and the other information comprises:
transmitting the reference signal or transmitting the reference signal and at least one of a channel or a signal of the serving cell on other component carriers (CCs) except a designated CC, in a case where the priority of the reference signal is higher than the priority of at least one of the channel or the signal of the serving cell, wherein the designated CC is a CC where the reference signal is located; or
transmitting the reference signal or transmitting the reference signal and at least one of other channel or other signal of the neighboring cell on other component carriers (CCs) except a designated CC, in a case where the priority of the reference signal is higher than the priority of at least one of the channel or the signal of the neighboring cell, wherein the designated CC is a CC where the reference signal is located.

15. (canceled)

16. The communication method according to claim 8, further comprising:
transmitting terminal capability information to a network device, wherein the terminal capability information comprises conflict determination mode indication information, and the conflict determination mode indication information is configured to indicate a determination mode for determining that the time domain for the reference signal conflicts with the time domain for the other information.

17. The communication method according to claim 16, wherein in a case where the terminal transmits the reference signal within the initial BWP, the terminal capability information further comprises at least one of the following:
a value of X1 and a value of Y1; or
a value of X2 and a value of Y2;
wherein the value of X1 and the value of Y1 are determined based on a subcarrier spacing (SCS) of the initial BWP; and the value of X2 and the value of Y2 are determined based on the SCS of the initial BWP.

18. (canceled)

19. The communication method according to claim 49, wherein in a case where the terminal transmits the reference signal on the bandwidth other than the initial BWP, the terminal capability information further comprises at least one of the following:
a value of X3 and a value of Y3; or
a value of X4 and a value of Y4;
wherein the value of X3 and the value of Y3 are determined based on a subcarrier spacing (SCS) of the initial BWP, or, the value of X3 and the value of Y3 are determined based on an SCS of a BWP where the reference signal is located; and
wherein the value of X4 and the value of Y4 are determined based on the SCS of the initial BWP, or, the value of X4 and the value of Y4 are determined based on the SCS of the BWP where the reference signal is located.

20-21. (canceled)

22. A communication method, performed by a network device, the communication method comprising:
determining, in a case where a terminal is in a non-connected state, a first configuration parameter;
wherein the first configuration parameter is configured to instruct the terminal to determine a reference signal processing window and to process a reference signal based on the reference signal processing window.

23. The communication method according to claim 22, further comprising at least one of the following:
transmitting, in a case where the non-connected state is an inactive state, a first radio resource control (RRC) release message to the terminal, wherein the first RRC release message comprises the first configuration parameter; or
transmitting, in a case where the terminal is in a connected state, a second configuration parameter to the terminal, wherein the second configuration parameter is a configuration parameter configured to configure the reference signal processing window while the terminal is in the connected state.

24. The communication method according to claim 22, wherein in a case where the non-connected state is an idle state, the communication method further comprises any one of the following:
transmitting to the terminal, in a case where the network device is a core network device, a configuration parameter configured to indicate the first configuration parameter;
transmitting to the terminal broadcast information carrying a configuration parameter configured to indicate the first configuration parameter;
transmitting a second radio resource control (RRC) release message to the terminal, wherein the second RRC release message comprises the first configuration parameter; or
transmitting to the terminal, in a random access (RA) procedure, a configuration parameter configured to indicate the first configuration parameter.

25. The communication method according to claim 22, wherein the first configuration parameter is further configured to:
instruct, in a case where a time domain for the reference signal conflicts with a time domain for other information, the terminal to process the reference signal, wherein the other information comprises at least one of any channel or any signal except the reference signal.

26. The communication method according to claim 25, wherein the other information comprises at least one of the following:
at least one of a channel or a signal of a serving cell; or
at least one of a channel or a signal of a neighboring cell.

27-44. (canceled)

45. A terminal, comprising:
a processor; and
a memory configured to store processor-executable instructions;
wherein the processor is configured to:
determine, in a case where the terminal is in a non-connected state, a first configuration parameter;
determine a reference signal processing window based on the first configuration parameter; and
process a reference signal based on the reference signal processing window.

46. A network device comprising:
a processor; and
a memory configured to store processor-executable instructions;
wherein the processor is configured to execute the processor-executable instructions to perform the communication method according to any one of claim 22.

47-48. (canceled)

49. The communication method according to claim 9, further comprising:
transmitting terminal capability information to a network device, wherein the terminal capability information comprises conflict determination mode indication information, and the conflict determination mode indication information is configured to indicate a determination mode for determining that the time domain for the reference signal conflicts with the time domain for the other information.
